(19) United States
(12) Patent Application Publication
(10) Pub. No.: US 2022/0072340 A1
(43) Pub. Date: Mar. 10, 2022

(54) Gas Guide Apparatus

(71) Applicant: MAGOS Co., Ltd., Kawaguchi-shi (JP)

(72) Inventor: Kazufuku NITTA, Kawaguchi (JP)

(21) Appl. No.: 17/468,949

(22) Filed: Sep. 8, 2021

(30) Foreign Application Priority Data
Sep. 10, 2020 (JP) 2020-151921

(51) Int. Cl. A62B 7/12; A41D 13/11; A62B 7/10; A62B 18/00

(52) U.S. Cl. CPC A62B 7/12; A62B 18/003; A62B 7/10; A41D 13/11

(57) ABSTRACT

A gas guide apparatus provides a user with a comfortable feel during use of a mask or the like. The gas guide apparatus includes a gas supply unit configured to supply a gas, a gas supply side tube unit configured to have a supply hole to emit the gas supplied from the gas supply unit outside, and a disposition unit configured to dispose the gas supply side tube unit on a face of a user with the supply hole opposed to the mouth vicinity area in front of the mouth of the user.

### CROSS REFERENCE TO RELATED APPLICATIONS

The present application is based on, and claims priority from JP Application Serial Number 2020-151921, filed Sep. 10, 2020, the disclosure of which is hereby incorporated by reference herein in its entirety.

### BACKGROUND

### Technical Field

The present invention relates to a gas guide apparatus that supplies a gas to a user's face and discharges the gas from near the face.

### Related Art

With the advent of the new coronavirus in recent years, people are wearing masks more frequently. A person wearing a mask can often feel uncomfortable due to the mask sticking to the nose or the mouth.

To resolve the uncomfortable feeling of the mask sticking to the nose or the mouth, a mask main body and an auxiliary spacer to be interposed between the mask main body and the face have been proposed (for example, see Japanese Patent Application Laid-Open No. 2015-019920). The auxiliary spacer is accommodated inside the mask and provides a space between the mask main body and the user's nostrils and mouth.

However, while the aforementioned mask provides a space between the mask main body and the user's nostrils and mouth, the auxiliary spacer surrounding the mouth has a structure not permeable to the outside air. This further increases the ventilation resistance of the mask and makes it hard to breathe.

If the user does intensive exercise with such a mask on, the cardiopulmonary function can be lowered by the ventilation resistance of the mask and his/her life can be endangered.

### SUMMARY

In view of the foregoing circumstances, the present invention provides a gas guide apparatus that provides a user with a comfortable feel during use of a mask or the like.

The present invention has been achieved in view of the aforementioned object, and provides a gas guide apparatus including: a gas supply unit configured to supply a gas; a gas supply side tube unit configured to guide the gas from the gas supply unit and to have a supply hole to emit the gas supplied from the gas supply unit; and a disposition unit configured to dispose the gas supply side tube unit on a face or a head of a user with the supply hole located near the face or the head of the user.

Regarding the gas guide apparatus, the disposition unit can dispose the gas supply side tube unit so that the supply hole is located in a vicinity area of a mouth of the user.

The gas guide apparatus can include a filter unit located on any of a gas suction path and a gas supply path of the gas supply unit.

Regarding the gas guide apparatus, the supply hole can emit the gas from a band-like emission area formed by a combination of a plurality of holes and/or a slit-like long hole.

Regarding the gas guide apparatus, the band-like emission area of the supply hole can extend in a width direction of the face of the user.

Regarding the gas guide apparatus, the band-like emission area of the supply hole can extend in a length direction of the face of the user.

Regarding the gas guide apparatus, the disposition unit can dispose the supply hole below the mouth of the user.

Regarding the gas guide apparatus, the disposition unit can dispose the supply hole above an eye of the user.

Regarding the gas guide apparatus, the disposition unit can dispose the supply hole on one side of the mouth of the user in a width direction thereof.

Regarding the gas guide apparatus, the supply hole can emit the gas at least from positions on both outer sides of a nose of the user in a width direction thereof.

Regarding the gas guide apparatus, the supply hole can include an upper hole that is located near the nose of the user and emits the gas to a front of the eye, and a lower hole that is located near the nose of the user and emits the gas to a front of the mouth.

The gas guide apparatus can include a guide surface that is opposed to the upper hole in a reference direction and tilts toward the front of the face, with a direction from the upper hole to the eye as the reference direction. The guide surface faces the upper side holes at a location closer to the nose side than the eyes of the user in the reference direction.

Regarding the gas guide apparatus, the disposition unit can include an ear hook portion to be worn on an ear of the user.

Regarding the gas guide apparatus, the disposition unit can include a rear side attachment portion to be worn on a back of the head or a neck of the user astride the back of the head or the neck in a width direction of the back of the head or the neck of the user.

Regarding the gas guide apparatus, the disposition unit can include a cover member engagement structure capable of engagement with a cover member configured to cover at least the mouth of the user to block a droplet from the mouth in an open state where the user is able to breathe freely, and the supply hole can supply the gas to between the cover member and the user.

Regarding the gas guide apparatus, the cover member can be a mask configured to cover the nose and the mouth of the user with a sheet material having enough air permeability for the user to breathe freely, and the cover member engagement structure can include hook portions to be engaged with portions of the mask to be put on both ears.

Regarding the gas guide apparatus, the cover member can be a mask configured to cover the nose and the mouth of the user with a sheet material having enough air permeability for the user to breathe freely, and the disposition unit can include an engagement portion that is positioned on an inner surface side of the mask by being located on the inner surface side of the mask and engaged with an inner surface or a peripheral edge of the mask.

Regarding the gas guide apparatus, the disposition unit can include a three-dimensional frame that is positioned to around the mouth and the nose of the user to cover the mouth and the nose of the user and is convex away from the mouth and the nose of the user to form a space in front of the area from the nose to the mouth of the user, and the mask can be worn over the three-dimensional frame and deformed into a three-dimensional shape convex away from the mouth and the nose of the user.

Regarding the gas guide apparatus, the disposition unit can have an exhaust hole that releases the gas emitted from the supply hole into an inside of the mask out of the mask.

Regarding the gas guide apparatus, the exhaust hole can be positioned to between an inner surface of the mask and the user by the disposition unit.

Regarding the gas guide apparatus, the cover member can be a face guard configured to cover at least the nose and the mouth of the user with a peripheral edge thereof open to outside, and the cover member engagement structure can include a face guard side frame portion that extends around the head of the user and a face guard side attachment portion that attaches the peripheral edge of the face guard to the face guard side frame portion in part.

Regarding the gas guide apparatus, the cover member can be a face guard configured to cover at least the nose and the mouth of the user with a peripheral edge thereof open to outside, and the cover member engagement structure can include a face guard fixing portion to be fixed to the face guard.

The gas guide apparatus can include a cushioning portion configured to, in a state where a part of the peripheral edge of the face guard is open, fill a gap between a rest of the peripheral edge and the user.

The gas guide apparatus can include a duct unit configured to connect the part of the peripheral edge to the gas supply unit.

Regarding the gas guide apparatus, the cover member engagement structure can include a swing mechanism configured to make the face guard swing about a swing axis.

The gas guide apparatus can include a cover member configured to cover the nose and the mouth of the user and the supply hole in a state where the user is able to breathe freely.

Regarding the gas guide apparatus, the cover member can be a mask configured to cover the nose and the mouth of the user with a sheet material having enough air permeability to enable the user to breathe freely.

Regarding the gas guide apparatus, the sheet material of the mask can have enough flexibility to be deformed by exhalation.

Regarding the gas guide apparatus, a pressure inside the cover member under an assumption that the user is in a not-breathing state can be A+0.2 cmH₂O or more, where atmospheric pressure is A cmH₂O.

Regarding the gas guide apparatus, a pressure inside the cover member under an assumption that the user is in a not-breathing state can be A+3.0 cmH₂O or less, where atmospheric pressure is A cmH₂O.

Regarding the gas guide apparatus, a minimum value of the pressure inside the cover member can be A−1.0 cmH₂O or more, where atmospheric pressure is A cmH₂O.

Regarding the gas guide apparatus, a minimum value of the pressure inside the cover member can be greater than or equal to atmospheric pressure.

Regarding the gas guide apparatus, the cover member can be a face guard configured to cover at least the nose and the mouth of the user with a peripheral edge thereof open.

Regarding the gas guide apparatus, the gas supplied from the supply hole to the vicinity area of the mouth of the user can have a flow rate of 20 L/min or more.

The gas guide apparatus can have an exhaust hole that releases the gas emitted from the supply hole.

The gas guide apparatus can include a gas collection side tube unit that has a collection hole for collecting the gas emitted from the supply hole, and a negative pressure generation unit configured to make inside of the gas collection side tube unit negative in pressure, and the disposition unit can dispose the gas collection side tube unit on the face or the head of the user so that the collection hole is located near the face or the head of the user. The gas guide apparatus can include an exhaust portion configured to have an exhaust hole to release the gas emitted from the gas from the supply hole to the outside. The disposition unit disposes the exhaust portion with the exhaust hole located near the face of the user. The disposition unit disposes the gas supply side tube unit and the exhaust portion so that a mouth of the user is located between the supply hole and the exhaust hole. The exhaust portion has a filter portion for the gas released from the exhaust hole to pass through.

Regarding the gas guide apparatus, a flow rate of the gas collected from the collection hole can be less than a flow rate of the gas emitted from the supply hole.

Regarding the gas guide apparatus, the collection hole can be plural and/or formed by a slit-like long hole, the plurality of collection holes and/or the slit-like long hole can form a band-like collection area.

Regarding the gas guide apparatus, the band-like collection area formed by the collection hole can extend in the width direction of the face of the user.

Regarding the gas guide apparatus, the band-like collection area formed by the collection hole can extend in the length direction of the face of the user.

Regarding the gas guide apparatus, the disposition unit can dispose the gas supply side tube unit and the gas collection side tube unit so that the mouth of the user is located between the supply hole and the collection hole.

Regarding the gas guide apparatus, the disposition unit can dispose the supply hole above the mouth of the user, and dispose the collection hole below the mouth of the user.

Regarding the gas guide apparatus, the disposition unit can dispose the collection hole above the mouth of the user, and dispose the supply hole below the mouth of the user.

Regarding the gas guide apparatus, the disposition unit can dispose the supply hole on one side of the mouth of the user in the width direction, and dispose the collection hole on the other side of the mouth of the user in the width direction.

Regarding the gas guide apparatus, the disposition unit can include a gas supply side frame portion configured to position the supply hole, a gas collection side frame portion configured to position the collection hole, and a connection portion configured to connect the gas supply side frame portion and the gas collection side frame portion.

Regarding the gas guide apparatus, the gas supply unit can include a blower configured to suck a gas and output the gas with a predetermined additional pressure, and the negative pressure generation unit can be configured to make the gas collection side tube unit negative in pressure with a suction force of the blower by connecting the gas collection side tube unit to a suction side of the blower.

Regarding the gas guide apparatus, the gas supply unit can be configured to suck both the gas collected from the gas collection side tube unit and air to supply the gas and the air to the gas supply side tube unit.

The gas guide apparatus can include a filter unit for the gas collected from the collection hole to pass through.

The gas guiding device is configured so that the gas passed through the filter unit can be guided to the suction side of the gas supply unit.

The gas guide apparatus can include a water absorbing member that is capable of retaining water, and the water can be vaporized by the gas emitted from the supply hole.

The gas guide apparatus can include a face side separation member that is located between the water absorbing member and the face of the user to separate the water in the water absorbing member from the face.

The gas guide apparatus can include an outer side separation member that is located on an opposite side of the water absorbing member from the face of the user to suppress movement of the water from the water absorbing member.

The gas guide apparatus can include a neck-specific gas supply side tube unit configured to guide the gas from the gas supply unit and to have a neck side supply hole for emitting the gas supplied from the gas supply unit to near the neck of the user.

The gas guide apparatus can include a neck side water absorbing member that is located near the neck side supply hole and capable of retaining water, and the water can be vaporized by the gas emitted from the neck side supply hole.

Regarding the gas guide apparatus, the disposition unit can include the ear hook portion to be worn on the ear of the user.

Regarding the gas guide apparatus, the disposition unit can include the rear side attachment portion to be worn astride the back of the head or the neck of the user in the width direction of the back of the head or the neck. Regarding the gas guide apparatus, the disposition unit can include an external fixing tool capable of detachably pinching an external member.

The gas guide apparatus can include a pressure measurement unit configured to measure a pressure of the gas emitted from the supply hole, and a control unit including a computer, and the control unit can include a supply flow rate controller configured to control the flow rate of the gas emitted from the supply hole on the basis of a pressure evaluation value derived from a result of a pressure measurement made by the pressure measurement unit.

Regarding the gas guide apparatus, the control unit can include a lower limit threshold determinator configured to determine whether the pressure evaluation value is less than a lower limit threshold, and the supply flow rate controller can increase an amount of gas supply if the lower limit threshold determinator determines that the pressure evaluation value is less than the lower limit threshold.

The gas guide apparatus can include a pressure measurement unit configured to measure a pressure of the gas emitted from the supply hole, and a control unit including a computer, and the control unit can include a collection flow rate controller configured to control an amount of gas collection from the collection hole on the basis of a pressure evaluation value derived from a result of a pressure measurement made by the pressure measurement unit.

The gas guide apparatus can include a control unit including a computer, and the control unit can include a collection flow rate determinator configured to determine the flow rate of the gas collected from the collection hole, and a collection flow rate controller configured to control an amount of gas collection from the collection hole on the basis of a result of a determination made by the collection flow rate determinator.

The gas guide apparatus can include a filter unit located on any of a gas suction path and a gas supply path of the gas supply unit.

Regarding the gas guide apparatus, the gas supply unit can include a blower; the gas guide apparatus can include a power consumption measurement unit configured to measure power consumption of the blower, and a control unit including a computer; and the control unit can include a supply flow rate controller that controls the flow rate of the gas emitted from the supply hole on the basis of an evaluation value derived from a result of a power consumption measurement made by the power consumption measurement unit.

Regarding the gas guide apparatus, the gas supply unit can include a blower; the gas guide apparatus includes a power consumption measurement unit configured to measure power consumption of the blower, and a control unit including a computer; and the control unit can include a collection flow rate controller configured to control an amount of gas collection from the collection hole on the basis of an evaluation value derived from a result of a power consumption measurement made by the power consumption measurement unit.

The present invention also provides a gas guide apparatus including: a gas collection side tube unit configured to have a collection hole for collecting a gas; a negative pressure generation unit configured to make an inside of the gas collection side tube unit negative in pressure; and a disposition unit configured to dispose the gas collection side tube unit on a face of a user with the collection hole located near the face of the user.

### Advantageous Effects of Invention

According to the gas guide apparatus of the present invention, the gas is supplied to the mouth vicinity area of a user. The gas is therefore supplied to the mouth of the user or the mouth vicinity area even when the user wears a mask. As a result, the user can breathe easily even with the mask on.

### BRIEF DESCRIPTION OF THE DRAWINGS

FIG. 1A is a front view of a user wearing a gas guide apparatus according to a first embodiment of the present invention, and FIG. 1B is a front view of the user wearing the gas guide apparatus according to the first embodiment of the same, showing the inside of a mask;

FIG. 2A is a side view of the user wearing the gas guide apparatus according to the first embodiment of the present invention without a mask, and FIG. 2B is a side view of the user wearing the gas guide apparatus according to the first embodiment of the present invention with a mask;

FIG. 3A is a side view of a disposition unit of the gas guide apparatus according to the first embodiment of the present invention, FIG. 3B is a side view of the user wearing the gas guide apparatus according to the first embodiment of the present invention, showing how the flowing direction of the gas is changed by an upper guide unit, and FIG. 3C is a partial enlarged cross-sectional side view of the gas guide apparatus in the nose vicinity area of the user;

FIG. 4A is a diagram showing a hardware configuration of a control unit of the gas guide apparatus according to the first embodiment of the present invention, and FIG. 4B is a functional block diagram of the control unit of the gas guide apparatus according to the first embodiment of the present invention;

FIG. 5A is a model diagram showing the time variations of pressure in a mouth vicinity area or nose vicinity area of the user wearing only a mask, and FIGS. 5B to 5D are model diagrams showing the time variations of pressure in the mouth vicinity area or nose vicinity area of the user wearing the gas guide apparatus according to the first embodiment with a mask on;

FIG. 6A is a side view showing a state where a mask sticks to the face of the user wearing only the mask, and FIG. 6B is a side view showing a gas flowing between a mask and the face of the user wearing the gas guide apparatus according to the first embodiment of the present invention with the mask;

FIG. 7 is a side view of the user wearing the gas guide apparatus according to the first embodiment of the present invention without a mask, showing a gas flowing in front of the face of the user;

FIG. 8A is a front view of the user wearing a modification of the gas guide apparatus according to the first embodiment of the present invention, and FIG. 8B is a side view thereof;

FIG. 9A is a front view of a user wearing a gas guide apparatus according to a second embodiment of the present invention, and FIG. 9B is a side view thereof;

FIG. 10A is a rear view of the user wearing a disposition unit of the gas guide apparatus according to the second embodiment of the same, and FIG. 10B is a side view of the user wearing the modification of the gas guide apparatus according to the second embodiment of the same;

FIG. 11A is a front view of a user wearing a gas guide apparatus according to a third embodiment of the present invention with a mask, and FIG. 11B is a front view of the user wearing the gas guide apparatus according to the third embodiment of the same, showing the inside of the mask;

FIG. 12A is a side view of the user wearing the gas guide apparatus according to the third embodiment of the same without a mask, and FIG. 12B is a side view of the user wearing the gas guide apparatus according to the third embodiment of the same with a mask on;

FIG. 13 is a side view of a disposition unit of the gas guide apparatus according to the third embodiment of the same;

FIG. 14 is a functional block diagram of a control unit of the gas guide apparatus according to the third embodiment of the same;

FIGS. 15A and 15B are model diagrams showing the time variations of pressure and the time variations of flow rate in a mouth vicinity area or nose vicinity area of the user wearing the gas guide apparatus according to the third embodiment of the same with a mask on;

FIGS. 16A and 16B are model diagrams showing the time variations of pressure, the time variations of gas supply flow rate, and the time variations of gas collection flow rate in the mouth vicinity area or nose vicinity area of the user wearing the gas guide apparatus according to the third embodiment of the same with a mask on;

FIG. 17A is a side view of the user wearing a modification of the gas guide apparatus of the third embodiment of the same, and FIGS. 17B and 17C are model diagrams showing the time variations of gas supply flow rate and the time variations of gas collection flow rate according to the modification;

FIG. 18A is a front view of a user wearing a gas guide apparatus according to a fourth embodiment of the present invention with a mask on, and FIG. 18B is a side view of the user wearing the gas guide apparatus according to the fourth embodiment of the same without a mask;

FIG. 19A is a front view of a user wearing a gas guide apparatus according to a fifth embodiment of the present invention with a mask on, and FIG. 19B is a rear view thereof;

FIG. 20 is a front view of a user wearing a gas guide apparatus according to a sixth embodiment of the present invention with a mask on;

FIG. 21A is a front view of the user wearing a modification of the gas guide apparatus according to the sixth embodiment of the same, and FIG. 21B is a cross-sectional view taken along the line B-B of FIG. 21A;

FIG. 22A is a front view of a user wearing a gas guide apparatus according to a seventh embodiment of the present invention with a mask on, and FIG. 22B is a partial enlarged cross-sectional side view of the gas guide apparatus;

FIG. 23 is a front view of a user wearing a gas guide apparatus according to an eighth embodiment of the present invention with a mask on;

FIG. 24A is a front view of a user wearing a gas guide apparatus according to a ninth embodiment of the present invention with a mask on, and FIG. 24B is a front view of the user wearing the gas guide apparatus according to the ninth embodiment of the present invention with a mask on, showing the inside of the mask;

FIG. 25A is a side view of the user wearing the gas guide apparatus according to the ninth embodiment of the present invention with a mask on, and FIG. 25B is a side view of the user wearing the gas guide apparatus according to the ninth embodiment of the present invention without a mask;

FIG. 26 is a front view of the user wearing a modification of the gas guide apparatus according to the ninth embodiment of the present invention with a mask on;

FIG. 27A is a front view of a user wearing a gas guide apparatus according to a tenth embodiment of the present invention with a face guard on, and FIG. 27B is a side view thereof;

FIG. 28 is a side view of the user wearing the gas guide apparatus according to the tenth embodiment of the present invention with the face guard on;

FIG. 29A is a front view of the user wearing a modification of the gas guide apparatus according to the tenth embodiment of the present invention with a face guard on, and FIG. 29B is a front view of the user wearing another modification of the gas guide apparatus according to the tenth embodiment of the present invention with a mask on;

FIG. 30 is a front view of a user wearing a gas guide apparatus according to an eleventh embodiment of the present invention with a mask on, showing the inside of the mask;

FIG. 31A is a front view of a user wearing a gas guide apparatus according to a twelfth embodiment of the present invention with a mask on, and FIG. 31B is a side view thereof;

FIG. 32 is a front view of the user wearing a modification of the gas guide apparatus according to the twelfth embodiment of the present invention with a mask on; And

FIG. 33A is a front view of the user wearing the gas guide apparatus according to the thirteenth embodiment of the present invention with a mask on, and FIG. 33B is a front view of the user wearing a modification of the gas guide apparatus according to the thirteenth embodiment of the present invention with a mask on.

### DETAILED DESCRIPTION

Embodiments of the present invention will be described below with reference to the accompanying drawings. In the drawings, parts or members designated by the same reference numerals represent the same or similar parts.

### First Embodiment

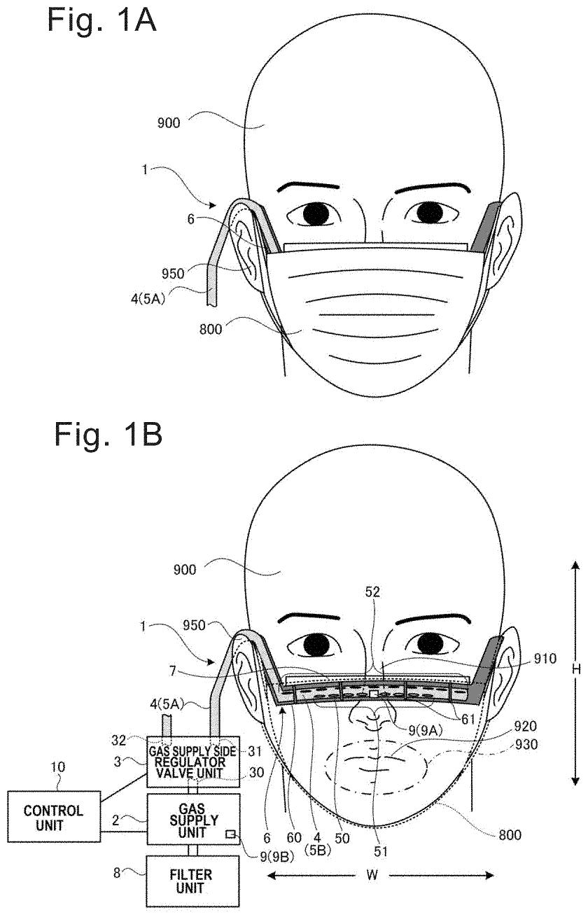

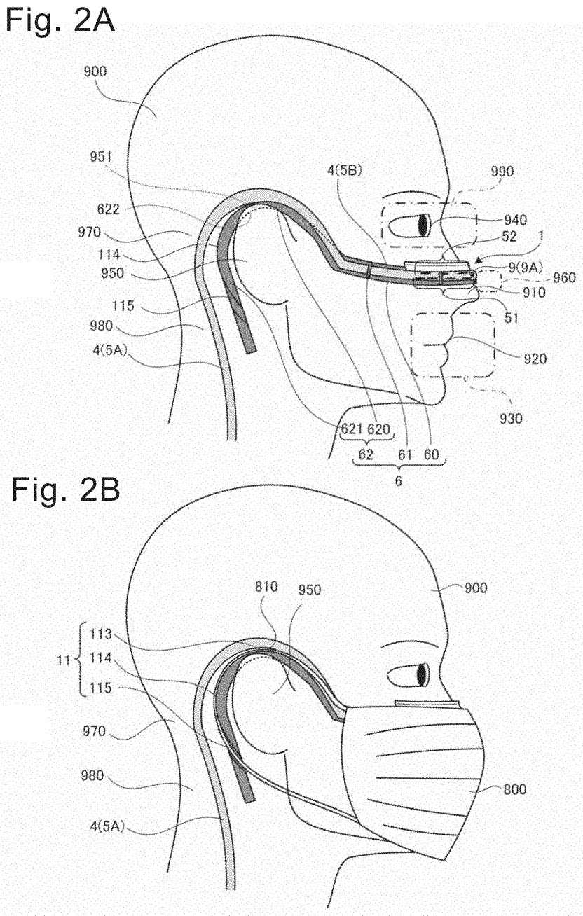

A gas guide apparatus 1 according to a first embodiment of the present invention will be described with reference to FIGS. 1A to 8B. As shown in FIG. 1A, the gas guide apparatus 1 according to the present embodiment is worn on the face of a user 900 with a mask 800 on, and supplies a gas to the face of the user 900 and discharges the gas from near the face of the user 900. As shown in FIGS. 1B, 2A, and 2B, the gas guide apparatus 1 includes a gas supply unit 2, a gas supply side regulator valve unit 3, a gas supply side tube unit 4, a disposition unit 6, an upper guide unit 7, a filter unit 8, a pressure measurement unit 9, a control unit 10, and a mask engagement structure 11.

<Gas Supply Unit>

The gas supply unit 2 supplies a gas. The gas supply unit 2 outputs the inputted gas with a predetermined additional pressure. For example, the gas supply unit 2 includes a blower, fan, or other compressor (in a broad sense, blower) in its casing. For example, the gas supply unit 2 is driven by a battery or the like, and is preferably as small in size so as to be able to put in a shirt chest pocket (not shown) of the user 900. The blower preferably has a boosting capability of 5 cmH₂O or more, desirably 10 cmH₂O or more, and still desirably 20 cmH₂O more.

<Gas Supply Side Regulator Valve Unit>

The gas supply side regulator valve unit 3 adjusts the amount of the gas flowing through the gas supply side tube unit 4 (or the amount of the gas emitted from supply holes 50). As shown in FIG. 1B, the gas supply side regulator valve unit 3 includes an input port part 30, a gas supply side output port part 31, and an atmosphere open side output port part 32. The input port part 30 is connected to the output side of the gas supply unit 2. The gas supply side output port part 31 is connected to the gas supply side tube unit 4. The atmosphere open side output port part 32 is open to the atmosphere. The gas supply side regulator valve unit 3 is controlled by the control unit 10 to open and close the gas supply side output port part 31 and the atmosphere open side output port part 32. For example, the gas supply side regulator valve unit 3 includes valves capable of electrical open and close controls, such as a solenoid valve. The valves are preferably configured so that the opening and closing ratio between the gas supply side output port part 31 and the atmosphere open side output port part 32 can be variably adjusted.

<Gas Supply Side Tube Unit>

The gas supply side tube unit 4 is a tube configured to guide the gas supplied from the gas supply unit 2 via the gas supply side regulator valve unit 3 to the supply holes 50. As shown in FIG. 1B, the gas supply side tube unit 4 includes an inlet tube portion 5A and an extended tube portion 5B. The inlet tube portion 5A is continuous with the gas supply side output port part 31 of the gas supply side regulator valve unit 3 at one end, and to the extended tube portion 5B at the other end. In the present embodiment, the inlet tube portion 5A is connected to the gas supply side output port part 31 of the gas supply side regulator valve unit 3 at one end, and is integrally formed with the extension pipe portion 5B. The inlet tube portion 5A is constituted by a resin tube, for example. Examples of the resin may include silicone.

The extended tube portion 5B is a tube for the gas supplied from the gas supply unit 2 via the inlet tube portion 5A to be passed through. As shown in FIG. 1B, the extended tube portion 5B is continuous with the inlet tube portion 5A at one end and closed at the other end. The extended tube portion 5B is made of a resin tube, for example. In the present embodiment, the inlet tube portion 5A and the extended tube portion 5B are integrally formed by a resin tube. Examples of the resin may include silicone. The extended tube portion 5B is disposed on the face of the user 900 by the disposition unit 6.

The inlet tube portion 5A is provided to give a degree of freedom to the installation position of the gas supply unit 2. The inlet tube portion 5A may therefore be omitted and the extended tube portion 5B may be directly connected to the gas supply unit 2 if the gas supply unit 2 (gas supply side regulator valve unit 3) can be located near the face of the user 900. The inlet tube portion 5A and the extended tube portion 5B may be either integrally formed or configured as respectively independent, separate members.

As shown in FIG. 1B, the extended tube portion 5B has a plurality of supply holes 50 for emitting the gas outside. The supply holes 50 are holes through the peripheral wall of the extended tube portion 5B, and communicate with the inside and outside of the extended tube portion 5B. A first supply hole group 51 which is a group of some of the plurality of supply holes 50 is arranged in a row along the axial direction of the extended tube portion 5B. As a result, the first supply hole group 51 forms a band-like emission area for emitting the gas in a band-like form in its entirety. A second supply hole group 52 that is a group of at least some of the rest of the plurality of supply holes 50 is arranged in a row along the axis direction (longitudinal direction) of the extended tube portion 5B at a position different from the first supply hole group 51. As a result, the second supply hole group 52 forms a band-like emission area for emitting the gas in a band-like form in its entirety. At least either one of the first and second supply hole groups 51 and 52 may be constituted by a slit-like long hole or a plurality of slit-like long holes.

The first supply hole group 51 is located near the nose 910 (both outer sides of the nose 910 in a width direction) and/or near the cheeks of the user 900 and emits the gas to the front of the mouth. The second supply hole group 52 is located near the nose 910 and/or the cheeks of the user 900 and emits the gas to the front of the eyes 940.

<Disposition Unit>

In the present embodiment, the disposition unit 6 disposes the extended tube portion 5B on a dorsum of the nose 910 of the user 900 as shown in FIG. 1B. Specifically, the extended tube portion 5B extends in a width direction W of the face of the user 900 and is positioned astride the dorsum of the nose 910 of the user 900. Of the plurality of supply holes 50, the first supply hole group 51 is directed toward an area (hereinafter, referred to as a mouth vicinity area) 930 in front of and near the mouth 920 of the user 900. In other words, the supply holes 50 constituting the first supply hole group 51 are composed of the lower holes directed downward. Of the plurality of supply holes 50, the second supply hole group 52 is directed toward an area (hereinafter, referred to as an eye vicinity area) 990 in front of and near the eyes 940 of the user 900. In other words, the supply holes 50 constituting the second supply hole group 52 are composed of the upper holes directed upward.

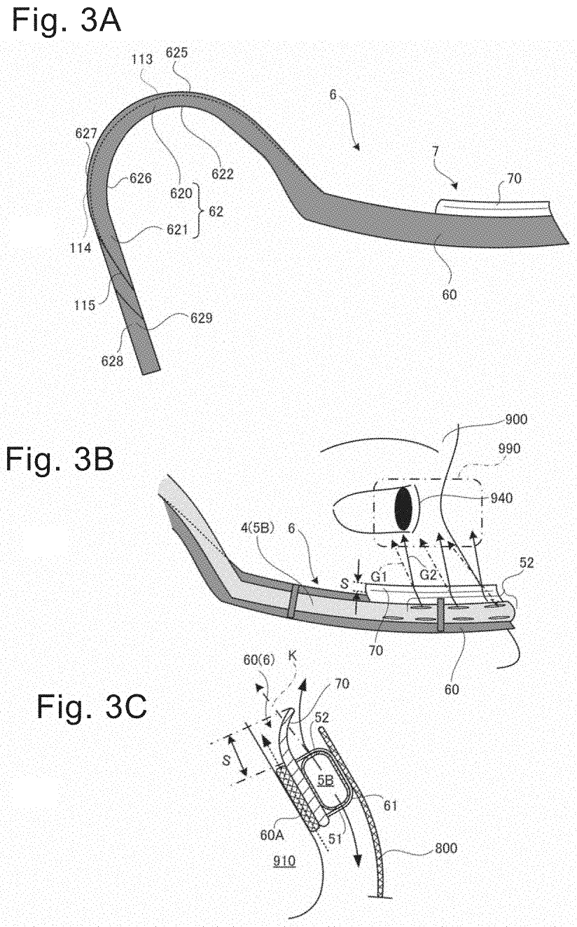

As shown in FIG. 2A, the disposition unit 6 includes a gas supply side frame portion 60, attachment portions 61, and head fixing side frame portions 62, for example. As shown in FIG. 1B, the gas supply side frame portion 60 is located to extend in the width direction W of the face of the user 900 and astride the dorsum of the nose 910 of the user 900. As shown in FIG. 3C, the gas supply side frame portion 60 includes an air permeable layer 60A at a position where the face (here, nose 910) of the user touches it. The gas supplied from the supply holes 50 passes through the air permeable layer 60A. For example, the air permeable layer 60A can be made of a resin material such as porous sponge or urethane foam, gathered cloth, nonwoven fabric, a three-dimensional resin mesh three-dimensionally molded in a thickness direction, a fiber mesh formed by three-dimensionally weaving fibers in the thickness direction, or the like. The attachment portions 61 are jigs configured to hold the extended tube portion 5B on the gas supply side frame portion 60 along the surface of the gas supply side frame portion 60. With such a structure, the gas supply side frame portion 60 can locate the supply holes 50 of the extended tube portion 5B in position.

As shown in FIG. 2A, the head fixing side frame portions 62 are continuous with the respective ends of the gas supply side frame portion 60 and extend over both sides of the head of the user 900. The head fixing side frame portions 62 are configured to put on the ears 950 in part. More specifically, as shown in FIG. 2A, each head fixing side frame portions 62 includes an ear hook portion 620 and a stopper portion 621. The ear hook portion 620 makes contact with an upper part of the root 951 of an ear 950 of the user 900. The stopper portion 621 extends from the ear hook portion 620 to the rear of the ear 950 of the user 900. The ear hook portion 620 extends from the front to behind the ear 950 of the user 900. The stopper portion 621 curves along the shape of the ear 950 of the user 900. When the gas supply side frame portion 60 moves forward away from the user 900, the stopper portion 621 comes into contact with the back of the ear 950 of the user 900 to prevent the gas supply side frame portion 60 from moving further toward the front of the user 900. The head fixing side frame portions 62 and the gas supply side frame portion 60 may be either integrally formed or configured as respectively independent, separate members.

When the head fixing side frame portions 62 are put on the ears 950 of the user 900, the gas supply side frame portion 60 is located astride the dorsum of the nose 910 of the user 900. While the head fixing side frame portions 62 here are described to be put on both ears, a head fixing side frame portion 62 may be formed to be only on one side and be put on only one ear for fixation. Moreover, in the present embodiment the head fixing side frame portions 62 are made of a rigid material, but is not limited to this, the head fixing side frame portions 62 may be omitted and the disposition unit 6 may be provided with rubber straps or strings for fixing to the head. In such a case, the disposition unit 6 can be fixed to the head with the rubber straps or the strings on the ears 950 or around the head.

<Upper Guide Unit>

As shown in FIG. 3B, the upper guide unit 7 guides the gas flowing directly toward the eyes 940 of the user 900 to flow toward the eye vicinity area 990 in front of and away from the eyes 940. As shown in FIG. 3A, the upper guide unit 7 is located on the gas supply side frame portion 60.

As shown in FIG. 3C, a direction directly pointing from the second supply hole group 52 to the eyes 940 will be referred to as a reference direction K. The upper guide unit 7 includes a guide surface 70 that is opposed to the second supply hole group 52 in the reference direction K and tilts toward the front of the face of the user 900 with respect to the reference direction K. For example, the guide surface 70 preferably forms a curled section S curling toward the front of the face of the user 900 on the side opposite the face of the user 900 of the upper guide unit 7. The guide surface 70 is interposed between the second supply hole group 52 and the eyes 940 of the user 900. The guide surface 70 is arranged to face the second supply hole group 52 (upper side holes) at a location closer to the nose 910 side than the eyes 940 of the user 900 in the reference direction K. The gas flowing directly toward the eyes 940 of the user 900 in the directions of the arrows G1 (reference direction K) impinges on the guide surface 70 and changes its flowing direction to the directions of the arrows G2. As a result, the gas flows upward through a area (or position) away from the eyes 940 in front of the face of the user 900. This can prevent the eyes 940 of the user 900 from drying out due to direct impingement of the gas.

<Filter Unit>

As shown in FIG. 1B, the filter unit 8 is located at a any position on the path (gas supply path) of the gas supplied from the gas supply unit 2 or on the path (supplied path) of the gas supplied to the gas supply unit 2, and removes pollen, dust, bacteria, viruses, and the like. In the present embodiment, the filter unit 8 can be located at any position from the gas supply unit 2 up to immediately before the supply holes 50 of the extended tube portion 5B. In the present embodiment, the filter unit 8 is located upstream (suction side or supplied path side) of the gas supply unit 2. It is preferable for the filter unit 8 to be capable of capturing suspended viruses in the passing gas.

<Pressure Measurement Unit>

The pressure measurement unit 9 measures the pressure of the gas supplied from the supply holes 50 to the front of the nose 910 or the mouth 920 of the user 900 at a given position. In the present embodiment, as shown in FIG. 1B, the pressure measurement unit 9 includes a first air pressure sensor 9A and a second air pressure sensor 9B. The first air pressure sensor 9A is located on the surface of or inside the extended tube portion 5B or on the surface of the gas supply side frame portion 60 so as to be on the internal space side of the mask 800. The second air pressure sensor 9B is located in the gas supply unit 2 and measures the atmospheric pressure. The pressure measurement unit 9 measures the pressure in an area (hereinafter, referred to as a nose vicinity area) 960 in front of and near the nose 910 of the user 900 (see FIG. 2A) by using the first air pressure sensor 9A. The internal pressure of the mask 800 can thus be measured. Note that the pressure measurement unit 9 may be located to measure the pressure in the mouth vicinity area 930 of the user 900. Alternatively, the pressure measurement unit 9 may measure the pressure inside the gas supply side tube unit 4, and estimate the pressure inside the mask 800 (in the nose vicinity area 960 or the mouth vicinity area 930) from the measurement. Measuring the atmospheric pressure by the second air pressure sensor 9B enables measurement of pressure differences of the nose vicinity area 960 or the mouth vicinity area 930 with reference to the atmospheric pressure. The second air pressure sensor 9B may be omitted since the atmospheric pressure can be measured by the first air pressure sensor 9A with the blower turned off or with the mask 800 off.

<Control Unit>

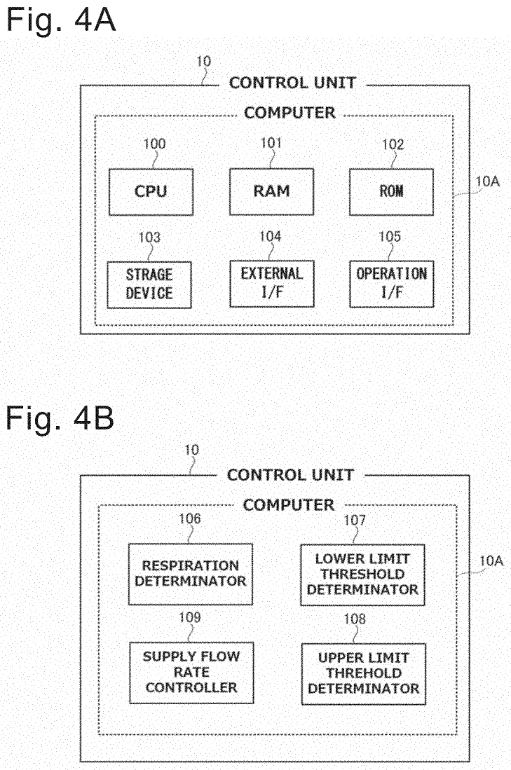

As shown in FIG. 4A, the control unit 10 includes a computer 10A including a CPU 100, a RAM 101, a ROM 102, a storage device 103, an external interface 104, and an operation interface 105. The CPU 100 is a central processing unit. The RAM 101 is a memory for reading and writing temporary data as a work area. The ROM 102 is a read-only memory storing predetermined programs. The storage device 103 includes a hard disk (HDD) or a solid state drive (SSD) into which predetermined programs, data, and the like can be written and stored. The external interface (I/F) 104 performs communication control with external devices. The operation interface 105 accepts the user's operations. For example, the operation interface 105 includes a power switch, a processing mode change switch, and a knob configured to adjust the amount of the gas supply (the amount of the gas collection) of the gas. The control unit 10 may include a (not-shown) display unit. In such a case, for example, the operation interface 105 may be implemented by a touch panel member mounted on the display unit. The display unit displays various types of information, such as the amount of the gas supply (the amount of the gas collection) of the gas, a processing mode, and the pressure inside the mask 800.

In the present embodiment, the control unit 10 controls the fan rotation speed of the blower in the gas supply unit 2 and the opening and closing operations of the gas supply side regulator valve unit 3 on the basis of measurement results obtained by the pressure measurement unit 9. Specifically, as shown in FIG. 4B, the control unit 10 includes a respiration determinator 106, a lower limit threshold determinator 107, an upper limit threshold determinator 108, and a supply flow rate controller 109.

The respiration determinator 106 determines an expiration state and an inspiration state of the user 900 on the basis of a respiration waveform obtained from the measurement result of the pressure measurement unit 9. Pressure noise waveforms irrelevant to the respiration waveform can be removed by referring to the respiration determinator 106. As will be described in detail below, the supply flow rate controller 109 can change the supply flow rate on the basis of inspiratory and expiratory time signals determined by the respiration determinator 106.

The lower limit threshold determinator 107 determines whether a pressure evaluation value calculated by using the pressure measured by the pressure measurement unit 9 falls below a lower limit threshold S1. Various values can be used as the pressure evaluation value. In the present embodiment, the minimum value of an inspiratory pressure inside the mask 800 with reference to the atmospheric pressure is used as the pressure evaluation value. The minimum value may be an average of inspiratory minimum values of a plurality of respiratory waveforms. An average pressure value obtained by averaging all high and low pressure values may be used as the pressure evaluation value. While an absolute pressure value can be used as the pressure evaluation value, it is preferable for a differential value with reference to the atmospheric pressure to be used. The lower limit threshold S1 is therefore also preferably a differential value with reference to the atmospheric pressure, although an absolute pressure value may be used.

The upper limit threshold determinator 108 determines whether a pressure evaluation value calculated by using the pressure measured by the pressure measurement unit 9 exceeds an upper limit threshold S2. Like the lower limit threshold determinator 107, the upper limit threshold determinator 108 can use various values as the pressure evaluation value. In the present embodiment, a maximum value of the expiratory pressure inside the mask 800 with reference to the atmospheric pressure is used. While the pressure evaluation value can be an absolute pressure value, it is preferable for a differential value with reference to the atmospheric pressure to be used. Again, the upper limit threshold S2 is therefore preferably a differential value with reference to the atmospheric pressure, although an absolute pressure value may be used.

The supply flow rate controller 109 increases the flow rate of the gas supplied from the supply holes 50 if the lower limit threshold determinator 107 determines that the minimum pressure inside the mask 800 falls below the lower limit threshold S1. As a result, the minimum pressure inside the mask 800 increases to reach or exceed the lower limit threshold S1. Specifically, the supply flow rate controller 109 increases the amount of the gas supplied to the extended tube portion 5B by opening the gas supply side output port part 31 of the gas supply side regulator valve unit 3 and closing the atmosphere open side output port part 32 thereby adjusting the opening and closing ratio between the two port parts. The amount of the gas supply can also be increased by increasing the fan rotation speed of the blower.

The supply flow rate controller 109 reduces the flow rate of the gas supplied from the supply holes 50 if the upper limit threshold determinator 108 determines that the maximum pressure inside the mask 800 exceeds the upper limit threshold S2. As a result, the maximum pressure inside the mask 800 falls to or below the upper limit threshold S2. Specifically, the supply flow rate controller 109 reduces the amount of the gas supplied to the extended tube portion 5B by closing the gas supply side output port 31 of the gas supply side regulator valve unit 3 and opening the atmosphere open side output port part 32 thereby adjusting the opening and closing ratio between the two port parts. The amount of the gas supply can also be reduced by reducing the fan rotation speed of the blower. Note that if both the upper limit threshold determinator 108 and the lower limit threshold determinator 107 make the determination operations at the same time, preferably, priority is given to control by the lower limit threshold determinator 107.

Moreover, the supply flow rate controller 109 can increase the supply flow rate when the user 900 is breathing in, and reduce the supply flow rate when the user 900 is breathing out. The inhalation time and exhalation time are determined by the respiration determinator 106.

<Mask Engagement Structure>

As shown in FIG. 2B, the mask engagement structure 11 is a structure included in the disposition unit 6 and capable of engagement with the mask 800. The user 900 wears the mask 800, with the mask 800 engaged with the mask engagement structure 11. The mask 800 itself is made of a sheet-like material (sheet material) having enough air permeability for the user 900 to easily breathe freely without needing external assistance. For example, the mask 800 is made of a flexible material such as nonwoven fabric, a porous resin, or cloth. The mask 800 thus has a function of blocking the passage of droplets such as saliva droplets, but with only a small (or hardly any) function of preventing the passage of viruses etc. The mask 800 “having enough air permeability for the user to easily breathe freely without needing external assistance” is called a surgical mask, for example, and is different from dustproof masks. Specifically, the sheet member of the mask 800 preferably has air permeability of less than 4.0 mmH₂O/cm² in terms of a pressure loss value according to the US standard ASTM F2100, more preferably 2.0 mmH₂O/cm² or less, still more preferably 1.8 mmH₂O/cm² or less, and most preferably 1.5 mmH₂O/cm² or less. The pressure loss value is determined by a technique defined by a mask pressure loss test (MIL-M-36954C) as follows. A humidity-controlled sheet material is attached to a sample holder (2.5 cm in diameter) and air is passed through by a suction pump with a flow rate of 8 L/min to measure the pressure loss (mmH₂O) at that time. The measurement is divided by the measurement area to obtain the pressure loss value. As another aspect of air permeability evaluation, a technique in which air is passed through the entire surface of the mask 800 with a flow rate of 40 L/min and the resulting pressure loss (Pa) measured at that time may be used. In such a case, the pressure loss is preferably less than 10.0 Pa, more desirably 5.0 Pa or less, and still more desirably 4.5 Pa or less.

It is preferable that the sheet material (filter material) of the mask 800 also have enough flexibility to be deformed by exhalation. Some masks 800 have enough rigidity to maintain their molded cup shape during wearing. However, such high-rigidity masks are less used considering portability and storage convenience in daily life. The present embodiment can add various functions while using an exhalation-deformable flexible mask 800 used for general purposes.

The mask 800 is worn in such a position that the nose 910 and the mouth 920 of the user 900 and at least the first supply hole group 51 of the extended tube portion 5B are covered by the mask 800. In the present embodiment, the head fixing side frame portions 62 of the disposition unit 6 serve also as the mask engagement structure 11. The mask engagement structure 11 includes first guide portions 113, hook portions 114, and second guide portions 115. The first guide portions 113 guide string portions 810 of the mask 800 to be put on the ears 950 of the user 900 from the front to behind the ears 950 of the user 900. The hook portions 114 are portions to be engaged with the string portions 810 of the mask 800 guided behind by the first guide portions 113, and which catch the string portions 810 of the mask 800. The second guide portions 115 guide the string portions 810 of the mask 800 from behind to the front of the ears 950 of the user 900.

More specifically, as shown in FIG. 3A, each first guide portion 113 is constituted by a groove that extends along a top surface 625 of the ear hook portion 620 and is recessed in a vertical thickness direction of the ear hook portion 620, for example. The vertical thickness direction refers to a direction from the top surface 625 to a bottom surface 622 of the ear hook portion 620. The groove constituting the first guide portion 113 is extended up to the front of the hook portion 114.

As shown in FIG. 3A, the hook portion 114 is constituted by a groove that extends along a rear surface 627 of the stopper portion 621 and is recessed in a front-rear thickness direction of the stopper portion 621. The front-rear thickness direction refers to a direction from the rear surface 627 to a front surface 626 of the stopper portion 621. It is preferable that both ends of the groove corresponding to the hook portion 114 be continuous with the first guide portion 113 and the second guide portion 115.

As shown in FIGS. 2B and 3A, the second guide portion 115 is constituted by a groove that extends along an outer surface 629 (in FIG. 3B, the near surface of the stopper portion 621) in an area of the stopper portion 621 near the back 970 of the head or the neck 980 and not in contact with the head. The second guide portion 115 is recessed in a lateral width direction of the stopper portion 621. The lateral width direction of the stopper portion 621 refers to a direction from the outer surface 629 to an inner surface 628 (this inner surface 628 is opposed to the head) of the stopper portion 621. The groove corresponding to the second guide portion 115 is continuous with the groove corresponding to the hook portion 114.

As shown in FIG. 2B, when the string portions 810 of the mask 800 are fitted into the grooves corresponding to the first guide portions 113, the hook portions 114, and the second guide portions 115, the strings portion 810 of the mask 800 are guided around the ears 950 of the user 900 without touching the skin of the user 900. As a result, the user 900 can wear the mask 800 without suffering burden from the string portions 810 of the mask 800.

As shown in FIG. 3C, the vicinity of the upper edge of the mask 800 makes contact with the front side of the extended tube portion 5B. As a result, the extended tube portion 5B itself serves as a boundary defining the inside and outside of the mask 800. The first supply hole group 51 emits the gas toward the internal space of the mask 800. The second supply hole group 52 emits the gas to the outside of the mask 800. Since the internal pressure of the mask 800 is increased by the gas emitted from the first supply hole group 51, part of the gas present inside is released outside the mask 800 through the air permeable layer 60A. As a result, the contact portion between the disposition unit 6 and the user's skin is cooled to provide a comfortable feel during wearing. The internal space of the mask 800 refers to a space between the face (mouth 920, nose 910, and the like) of the user 900 and the inner surface of the mask 800.

<Detailed Description of Pressure Control by Control Unit>

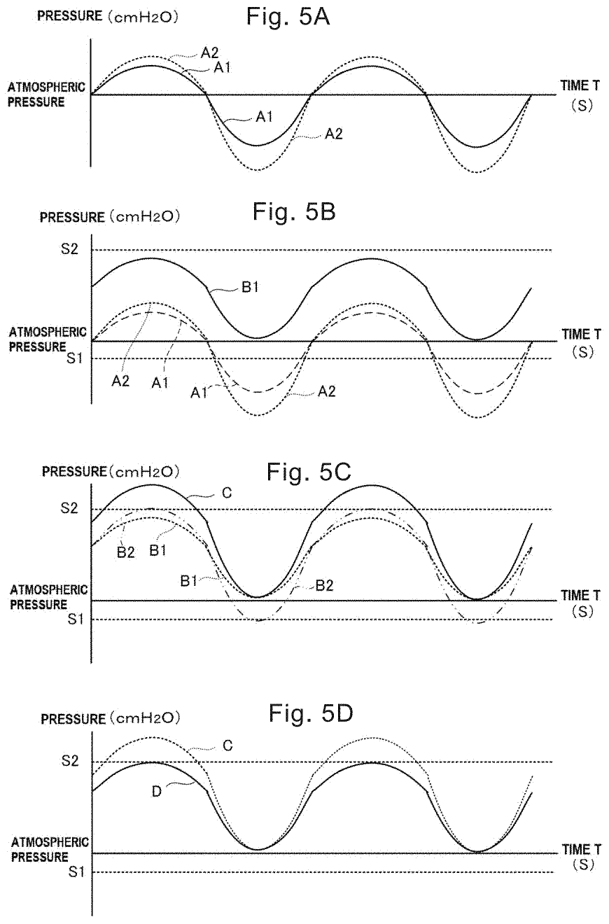

Next, pressure control by the control unit 10 will be described. A solid line A1 in FIG. 5A represents an internal pressure variation model for the mask 800 when the user 900 is breathing as if in a daily life situation (steady state) with only the mask 800 on. Because of the ventilation resistance of the mask 800, the pressure during exhalation becomes positive and the pressure during inhalation becomes negative with reference to the atmospheric pressure (0).

Such a load during respiration tends to tire the user 900 using the mask 800. In particular, the flexible mask 800 easily deformable by pressure variations gives the user 900 a somewhat stuffy feel since the mask 800 approaches the mouth during inhalation resulting in the increase in the pressure drop range on the negative pressure side. The internal pressure of the mask 800 with reference to the atmospheric pressure (0) typically varies in the range of −1.0 cmH₂O to +1.0 cmH₂O, more specifically −0.5 cmH₂O to +0.5 cmH₂O, depending on the porosity (ventilation resistance) of the mask 800.

A dotted line A2 represents a pressure variation model in a case where the user 900 does intensive exercise (hyperactive state) with only the mask 800 on. In the hyperactive state, the amount of ventilation per respiration increases, and thus the range of pressure variations increases compared to the steady state represented by the solid line A1. For example, the negative pressure can exceed −0.5 cmH₂O or even −1.0 cmH₂O. The positive pressure can also exceed +0.5 cmH₂O or even +1.0 cmH₂O. Too wide a range of pressure variations can cause a deterioration of the lung function.

A solid line B1 in FIG. 5B represents an internal pressure variation model for the mask 800 in the steady state where the gas guide apparatus 1 according to the present embodiment is used. Here, the same mask 800 is assumed to be used at the same active level as in the steady state of FIG. 5A. A dotted line A1 in FIG. 5B represents the pressure variation model of FIG. 5A.

With the gas guide apparatus 1, the control unit 10 controls the amount of the gas supply of the gas supplied from the supply holes 50 to the internal space of the mask 800. As a result, the internal pressure of the mask 800 increases. The control unit 10 controls the amount of the gas supply to increase the internal pressure by 0.2 cmH₂O or more, preferably 0.4 cmH₂O or more, with reference to the pressure variation model A1 of FIG. 5A (see the solid line A1 in FIG. 5A) (in other words, a state where the gas supply by the gas guide apparatus 1 is off, or an atmospheric pressure state).

Specifically, assuming a state where the user 900 is not breathing (non-breathing state), the control unit 10 controls the amount of the gas supply so that the internal pressure of the mask 800 is atmospheric pressure+0.2 cmH₂O or more, preferably 0.4 cmH₂O or more.

Meanwhile, the control unit 10 controls the amount of the gas supply so that the range of the increase in the internal pressure with reference to the pressure variation model A1 is 3.0 cmH₂O or less, preferably 2.0 cmH₂O or less, and more preferably 1.5 cmH₂O or less.

The control unit 10 preferably increases the internal pressure of the mask 800 so that the internal pressure will not become negative during respiration. While the mask 800 itself is unable to prevent the intrusion of viruses, maintaining a positive pressure inside can suppress the intrusion of viruses through the main body of the mask 800 and gaps around.

To obtain the aforementioned range of the increase in the internal pressure, it is preferable that the gas be supplied from the supply holes 50 to inside the mask 800 at 20 L/min or more, and more preferably 40 L/min or more. Meanwhile, it is preferable that the gas be supplied from the supply holes 50 to inside the mask 800 at 60 L/min or less, and more preferably 50 L/min or less. Note that the supply flow rate needs to be changed depending on the sheet material of the mask 800 and a gap formed between the mask 800 and the user 900. It is preferably that the gas be supplied at 30 L/min to 50 L/min. The gas also plays a role in positively agitating the space inside the mask 800.

Since the gas guide apparatus 1 maintains the internal pressure of the mask 800 positive during inhalation, the inhalation resistance to the user wearing the mask 800 becomes substantially the same as that of no mask. This provides a comfortable feel during extended use. In the steady state, the lower limit value of the pressure variation model represented by the solid line A1 does not fall below the lower limit threshold S1, and the upper limit value does not exceed the upper limit threshold S2.

A solid line C in FIG. 5C represents a pressure variation model for the internal space of the mask 800 controlled for the hyperactive state, using the gas guide apparatus 1 according to the present embodiment. A dotted line B1 in FIG. 5C represents the pressure variation model for the steady state shown by the solid line B1 of FIG. 5B. A double-dotted dashed line B2 represents a pressure variation model at an instant when the user shifts from the steady state to the hyperactive state while the control state is maintained as shown by the solid line B1 of FIG. 5B.

As shown by the double-dotted dashed line B2, when the user enters the hyperactive state while the control mode is maintained as in the steady state of FIG. 5B, the range of pressure variation increases and the lower limit value becomes less than the atmospheric pressure, i.e., enters a negative pressure state. Since the lower limit value falls below the lower limit threshold S1, the lower limit threshold determinator 107 of the control unit 10 detects the state. On the basis of the determination result, the supply flow rate controller 109 controls the amount of the gas supply to increase the internal pressure of the mask 800, so that the lower limit value of the pressure variations reaches or exceeds the lower limit threshold S1. Here, the lower limit value of the pressure variations is increased to a positive pressure.

As a result, despite the intensive exercise with the mask 800 on, the inhalation resistance to the user becomes close to that of no mask. This provides a comfortable feel during extended use. Note that the lower limit control is given priority although the upper limit value of the pressure variation model shown by the solid line C in FIG. 5C exceeds the upper limit threshold S2. Now, suppose the upper limit threshold determinator 108 detects that the maximum value during exhalation exceeds the upper limit threshold S2 while in a state where the minimum value of the pressure inside the mask 800 during inhalation exceeds the lower limit threshold S1. In such a case, the supply flow rate controller 109 may reduce the flow rate of the gas supplied from the supply holes 50 within a range where the minimum value does not fall below the lower limit threshold S1. The reason is that too high a pressure during exhalation makes the user 900 hard to breath out during exhalation.

A solid line D in FIG. 5D shows a variation in control of FIG. 5B or 5C. Here, the amount of the gas supply during inhalation is increased to maintain a state where the minimum value of the internal pressure of the mask 800 exceeds the lower limit threshold S1 or becomes positive. Meanwhile, it is preferable for the amount of the gas supply during exhalation to be reduced or set to zero to reduce the upper limit value of the internal pressure of the mask 800. Battery consumption can be reduced by reducing the fan rotation speed of the blower during exhalation.

Here, the lower limit threshold S1 is set within the range of −0.2 cmH₂O from the atmospheric pressure. However, it is preferable that the lower limit threshold S1 be set within the range of, e.g., −0.5 cmH₂O to +0.5 cmH₂O, more preferably within the range of −0.3 cmH₂O to +0.3 cmH₂O, and still more preferably within the range of −0.1 cmH₂O to +0.1 cmH₂O. It is also desirable that the lower limit threshold S1 be set to or below the atmospheric pressure (0.0 cmH₂O).

The pressure variation waveforms shown in FIGS. 5A to 5D are model representations of the pressure variations in the space between the user 900 and the mask 800 (mouth vicinity area 930 or nose vicinity area 960) and different from actual waveforms. In the present embodiment, it is described that the amount of the gas supply is to be controlled by determining the internal pressure state of the mask 800 using the lower limit threshold S1 and the upper limit threshold S2. However, the control technique according to the present invention also covers the cases of controlling the amount of the gas supply using an overall average pressure or other pressure-related indexes. Furthermore, a structure configured to manually control the amount of the gas supply to increase the pressure inside the mask 800 (make the pressure positive in particular) without measuring the internal pressure of the mask 800 is also included in the concept of the present invention.

<Other Advantages of Gas Guide Apparatus>

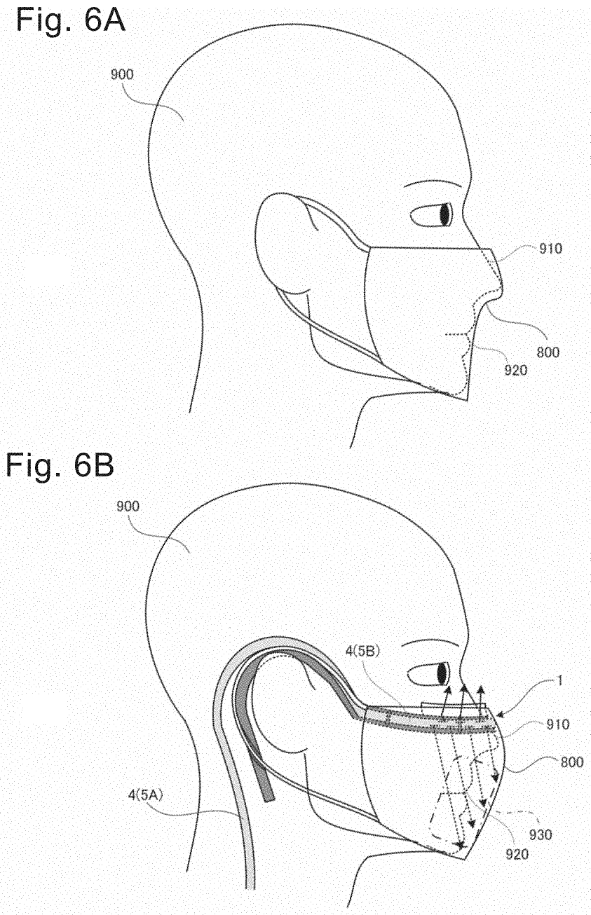

For example, suppose that the user 900 is running with the mask 800 on, and the amount of inhalation is greater than usual. In such a case, as shown in FIG. 6A, the mask 800 tends to stick to the face of the user 900 (nose 910 and mouth 920) causing a reduction in ventilation area and an increase in inhalation resistance. When the gas guide apparatus 1 according to the present embodiment is used, as shown in FIG. 6B, the gas supplied from near the nose 910 to the mouth vicinity area 930 impinges on the mask 800 and spreads out the mask 800 by its wind pressure or positive pressure. This can provide some ventilation area over the entire mask 800 at all times.

The gas supplied into the mask 800 has been passed through the filter unit 8 and is rid of viruses. Since the clean gas is constantly supplied into the mask 800, infection risk to the user can be reduced even if there are viruses suspended in the ambient atmosphere. Moreover, since the mask 800 itself is made of an air permeable material, the clean gas supplied inside makes the internal pressure of the mask 800 positive and continues gradually leaking out through the material of the mask 800. This can reduce the risk of intrusion of viruses from the outside through the material of the mask 800. Meanwhile, the mask 800 can reliably prevent droplets produced by the user's coughs, sneezes, and the like from being released to the outside. At the same time, the clean gas emitted from the second supply hole group 52 flows upward in front of the eyes of the user 900 as an air curtain. This can reduce the intrusion of viruses and the like into the eyes of the user 900.

The gas supplied into the mask 800 can also cool the internal space of the mask 800 itself. Making the pressure inside the mask 800 positive so that the supplied gas leaks out from the portions in contact with the user's skin, these contacting portions can also be cooled down. This can provide a comfortable feel during use.

Moreover, since the gas guide apparatus 1 according to the present embodiment supplies the gas to the internal space of the mask 800, which has enough air permeability for natural respiration, the internal pressure of the mask 800 will not increase excessively. In other words, unlike artificial respirators and respiratory support devices such as a CPAP, the gas guide apparatus 1 does not assist the user's respiration itself but has the function of controlling the environment outside the mouth during natural respiration. The gas guide apparatus 1 therefore will not affect the user's cardiopulmonary function even if the blower stops due to a dead battery.

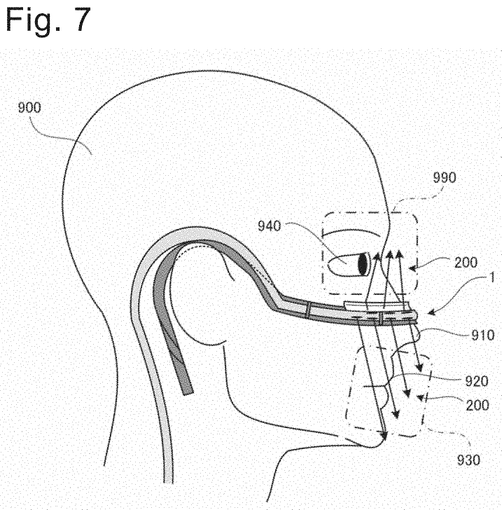

While the advantages to the user 900 wearing the mask 800 have been described above, the gas guide apparatus 1 according to the present embodiment is also effective for the user 900 not wearing the mask 800. Suppose that the user 900 wears the gas guide apparatus 1 according to the present embodiment as shown in FIG. 7. In such a case, there are formed a flow of clean gas passing through the mouth vicinity area 930 downward from the nose and a flow of clean gas passing through the eye vicinity area 990 upward from the nose. The gas flows form air curtains 200 in areas in front of and near the face of the user 900 (hereinafter, referred to as face vicinity areas), and prevent the intrusion of viruses and the like into the body via the face of the user 900. That is, the risk of virus infection can be reduced even when the user 900 is unable to wear the mask 800 during eating etc.

### Modification of Present Embodiment

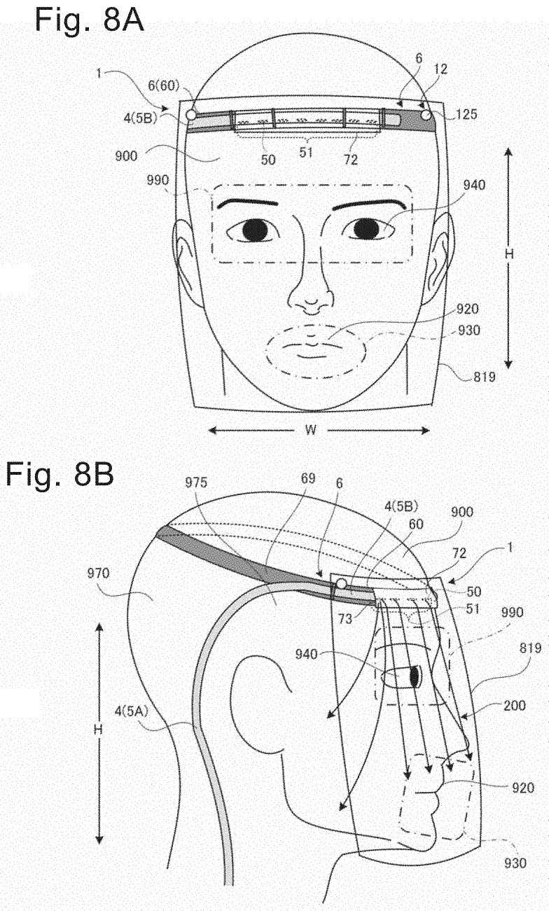

As a modification of the gas guide apparatus 1 according to the present embodiment, FIGS. 8A and 8B show a structure where the extended tube portion 5B is located above the eyes 940 of the user 900 in a length direction H of the face. Specifically, it is preferable that the extended tube portion 5B be disposed on the forehead (frontal region of the head) of the user 900 by the disposition unit 6 (gas supply side frame portion 60).

While the user 900 may wear the disposition unit 6 (gas supply side frame portion 60) on the ears 950 of the user 900, the user 900 can also wear the disposition unit 6 above the eyes 940 of the user 900 in the length direction H of the face, around the head of the user 900 as shown in FIGS. 8A and 8B, for example. In such a case, a head side mount portion 69 lying between both sides 975 of the head of the user 900 astride the back 970 of the head extends around the head of the user 900 in a cooperative manner with the gas supply side frame portion 60.

The support holes 50 constituting the first supply hole group 51 according to the present modification are each directed so that the emitted gas passes through the eye vicinity area 990 and the mouth vicinity area 930. The disposition unit 6 (gas supply side frame portion 60) may include a lower guide portion 72 so that the gas emitted from the first supply hole group 51 passes through the eye vicinity area 990 and the mouth vicinity area 930.

The lower guide portion 72 includes a guide surface 73 configured to guide the emitted gas to the eye vicinity area 990 and the mouth vicinity area 930. The guide surface 73 has a section opposed to the first supply hole group 51. The tilt angle of the section with reference to the length direction H of the face decreases with distance downward from a starting point above the first supply hole group 51 in the length direction H of the face. The emitted gas is deflected by the section of the guide surface 73 toward the eye vicinity area 990 and the mouth vicinity area 930.

The gas guide apparatus 1 according to the present modification, the emitted gas from the first supply hole group 51 forms an air curtain 200 in the face vicinity areas of the user 900 to prevent viruses and the like from intruding into the body via the face of the user 900.

As shown in FIGS. 8A and 8B, the gas guide apparatus 1 may preferably include a face guard 819 covering the entire face of the user 900. The face guard 819 covers in front of the supply holes 50. The face guard 819 is made of a transparent resin plate. The transparent resin plate is engaged with the disposition unit 6 by a face guard engagement structure 12 capable of engagement with the transparent resin plate (face guard 819). The face guard engagement structure 12 includes face guard fixing portions 125 that fix the vicinity of the upper edge of the transparent resin plate to the disposition unit 6 (gas supply side frame portion 60). The transparent resin plate is thereby fixed to the disposition unit 6. The disposition unit 6 and the extended tube portion 5B thus extend to form a closed structure between the vicinity of the upper edge of the face guard 819 and the user 900. On the other hand, both side edges and the lower edge of the face guard 819 have an open structure away from the user 900.

The air curtain 200 emitted from the supply holes 50 therefore descends along the inside (face-side) surface of the face guard 819, and the gas of the air curtain 200 is released to the outside from the open ends that are both the side edges and the lower edge. Since the face guard 819 has the closed structure on the upper edge side, intake of outside air from above related to the air curtain 200 can be prevented. This makes the intrusion of viruses from outside to the inside of the face guard 819 difficult. Note that if the face guard 819 is used, the gas emitted from the supply holes 50 is preferably made to impinge on the face guard 819, whereby the gas can be passed along the surface of the face guard 819.

### Second Embodiment

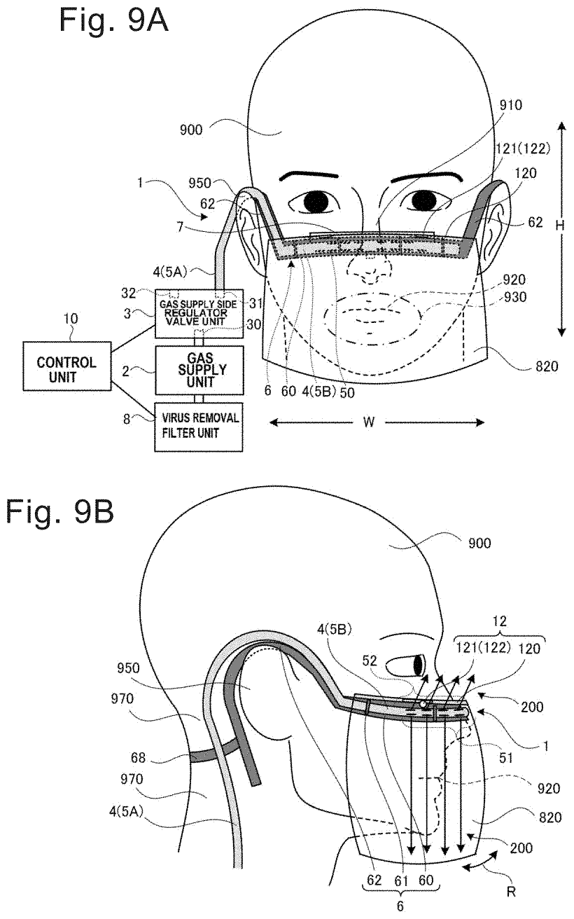

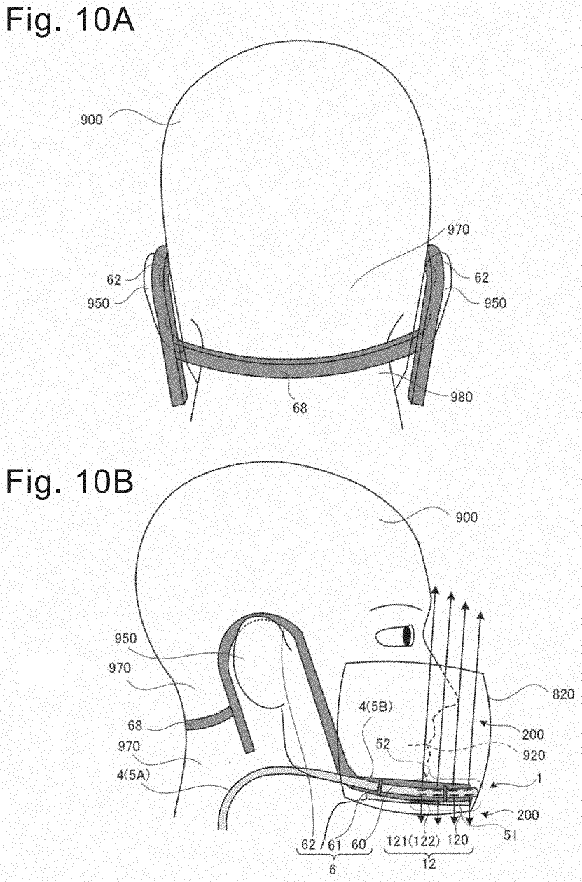

Next, a gas guide apparatus 1 according to a second embodiment of the present invention will be described with reference to FIGS. 9A to 10B. As shown in FIGS. 9A and 9B, the gas guide apparatus 1 according to the present embodiment is worn on the face of a user 900 who wears a face guard 820. The face guard 820 covers the nose 910 and the mouth 920 of the user 900 like the mask 800, whereas the face guard 820 has an open structure that both side edges and the lower edge are away from the user 900. The gas guide apparatus 1 according to the present embodiment has a similar structure to that of the gas guide apparatus 1 according to the first embodiment and the modification of FIGS. 8A and 8B for the most part. Differences in structure will be described below.

The gas guide apparatus 1 according to the present embodiment includes a face guard engagement structure 12 instead of the mask engagement structure 11 according to the first embodiment. The face guard engagement structure 12 is a structure included in the disposition unit 6 and capable of engagement with the face guard 820. With the face guard 820 engaged with the face guard engagement structure 12, the user 900 wears the face guard 820 so that the nose 910 and the mouth 920 of the user 900 and the extended tube portion 5B are covered therewith. As shown in FIG. 9B, the face guard engagement structure 12 includes a face guard side frame portion 120 and a face guard side attachment portion 121, for example.

As shown in FIG. 9A, the face guard side frame portion 120 extends astride the dorsum of the nose 910 of the user 900 in the width direction W of the face of the user 900. The face guard side frame portion 120 is connected to the gas supply side frame portion 60 or the head fixing side frame portions 62 and held by the gas supply side frame portion 60 or the head fixing side frame portions 62. A common frame member may be configured to serve as both the face guard side frame portion 120 and the gas supply side frame portion 60.

The face guard side fame portion 120 includes a swing mechanism 122. The swing mechanism 122 is configured to let an object swing about a (not-shown) swing axis extending the width direction W of the face of the user 900.

The face guard side attachment portion 121 is configured to attach the top end of the face guard 820 or the vicinity thereof to the swing mechanism 122 (face guard side frame portion 120). This makes the face guard 820 swingable in a front-to-back direction as shown by the arrow R in FIG. 9B. The user 900 swings the face guard 820 forward away from the mouth 920 during eating etc.

As shown in FIG. 9A, the gas supply side frame portion 60 is connected to the head fixing side frame portions 62 at both ends. As shown in FIGS. 9B, 10A, and 10B, a bridge portion 68 bridging the two head fixing side frame portions 62 is located between the two head fixing side frame portions 62.

With the two head fixing side frame portions 62 on both ears 950 of the 900, the gas supply side frame portion 60 is located astride the dorsum of the nose 910 of the user 900. As shown in FIG. 10A, the bridge portion 68 is located laterally astride the back 970 of the head or the neck 980 of the user 900 along the back 970 of the head or the neck 980. With the disposition unit 6 configured thus, the gas supply side frame portion 60 is supported by the two head fixing side frame portions 62. Since the bridge portion 68 functions as a stopper configured to prevent the disposition unit 6 from shifting forward in front of the user 900, the orientation of the extended tube portion 5B with respect to the user 900 is stabilized. The bridge portion 68 thus plays a role as a rear side mounting portion to be mounted on the user 900 on the rear side of the user 900. In the gas guide apparatus 1 according to the first embodiment, a forward shift is prevented by the stopper portions 621 of the head fixing side frame portions 62. In the second embodiment, the stopper portions 621 may be omitted since the bridge portion 68 can play the role.

According to the gas guide apparatus 1 of the second embodiment, the lower air curtain 200 formed by the gas emitted from the first supply hole group 51 directed downward descends along the inside (face-side) surface of the face guard 820 while the gas is released to the outside from the open ends at both side edges and the lower edge of the face guard 820. The gas emitted from the second supply hole group 52 forms the upper air curtain 200 flowing upward on the upper edge side of the face guard 820. This can prevent the intake of outside air from above in a manner linked with the lower air curtain 200. This makes the intrusion of viruses outside into the inside of the face guard 820 difficult.

FIG. 10B shows a gas guide apparatus 1 that is a modification of the second embodiment. In this gas guide apparatus 1, the gas supply side frame portion 60 and the face guard side frame portion 120 extend astride near the chin of the user 900 in the width direction. The lower end of the face guard 820 or the vicinity thereof is held by the face guard side frame portion 120. An upper air curtain 200 formed by the gas emitted from the upper second supply hole group 52 directed upward thus ascends along the inside (face-side) surface of the face guard 820 while the gas is released to the outside from the open ends at both side edges and the upper edge of the face guard 820. The gas emitted from the first supply hole group 51 forms a lower air curtain 200 flowing downward on the lower edge side of the face guard 820. This prevents the intake of outside air from below the chin in a manner linked with the upper air curtain 200. This makes the intrusion of viruses outside into the inside of the face guard 820 difficult. Moreover, since the upper air curtain 200 past the face guard 820 also passes in front of the eyes of the user 900, the intrusion of viruses nearby into the eyes can be prevented.

### Third Embodiment

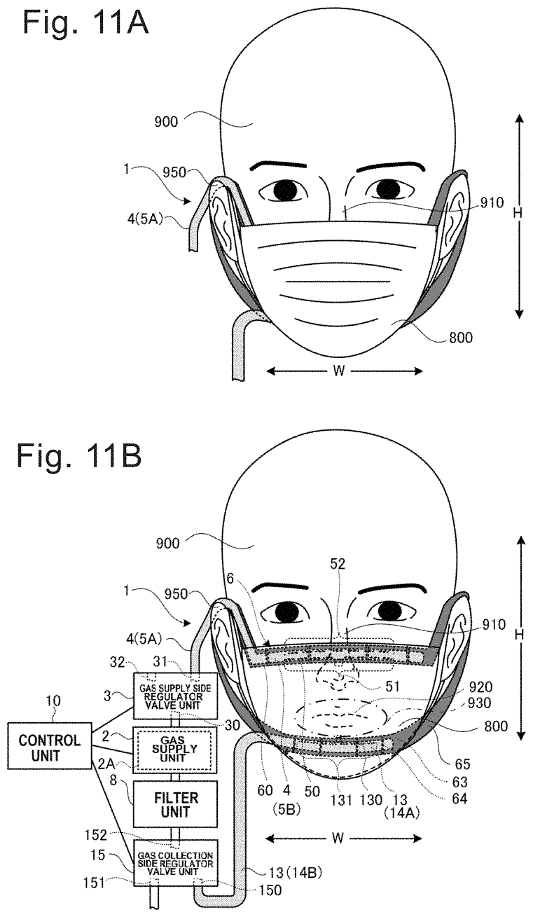

A gas guide apparatus 1 according to a third embodiment of the present invention will be described with reference to FIGS. 11A to 17C. As shown in FIG. 11A, the gas guide apparatus 1 according to the present embodiment is worn on the face of a user 900 who wears a mask 800. Since the gas guide apparatus 1 according to the present embodiment has a similar structure to that of the gas guide apparatus 1 according to the first embodiment for the most part, differences in structure will be described below.

As shown in FIG. 11B, the gas guide apparatus 1 according to the present embodiment includes a gas collection side tube unit 13, a gas collection side regulator valve unit 15, and a negative pressure generation unit 2A. The disposition unit 6 and the control unit 10 of the gas guide apparatus 1 according to the present embodiment have different configurations from those of the disposition unit 6 and the control unit 10 of the gas guide apparatus 1 according to the first embodiment.

<Gas Collection Side Tube Unit>

The gas collection side tube unit 13 is a tube having a plurality of collection holes 130 for collecting the gas emitted from the supply holes 50. The gas collection side tube unit 13 includes a collection side extended tube portion 14A and an outlet tube portion 14B. One end of the outlet tube portion 14B is continuous with the collection side extended tube portion 14A. The other end is continuous with the negative pressure generation unit 2A (implemented by the gas supply unit 2) via the gas collection side regulator valve unit 15 and the filter unit 8. For example, the outlet tube portion 14B is made of a resin tube. Examples of the resin include silicone.

The mouth 920 of the user 900 is positioned between the collection holes 130 and the supply holes 50. In other words, the gas supplied from the supply holes 50 passes in front of the mouth and reaches the collection holes 130.

The collection side extended tube portion 14A is continuous with the outlet tube portion 14B at one end and closed at the other end. For example, the collection side extended tube portion 14A is made of a resin tube. Examples of the resin include silicone.

The disposition unit 6 disposes the collection side extended tube portion 14A on the face of the user 900 (between under the mouth and the chin) in parallel with the width direction W of the face of the user 900. The outlet tube portion 14B is configured to give a degree of freedom to the installation position of the negative pressure generation unit 2A. The outlet tube portion 14B may therefore be omitted and the negative pressure generation unit 2A may be directly connected to the collection side extended tube portion 14A if the negative pressure generation unit 2A can be located near the face of the user 900.

The collection side extended tube portion 14A includes the plurality of collection holes 130 for collecting ambient gas. The collection holes 130 are holes through the peripheral wall of the collection side extended tube portion 14A, and communicate with the inside and outside of the collection side extended tube portion 14A. A collection hole group 131 that is a group of the plurality of collection holes 130 is located so that the collection holes 130 are arranged in a row along the axial direction (longitudinal direction) of the collection side extended tube portion 14A. The collection hole group 131 forms a band-like collection area for sucking in the gas in a band-like form in its entirety. Note that the number of collection holes 130 may be one. The collection hole(s) 130 may be shaped as a long hole or holes. The collection side extended tube portion 14A and the outlet tube portion 14B may be either integrally formed or configured as respectively independent, interconnectable separate members. If both are separate members, they are connected by means of a connection. The connection means consists, for example, of an independent connection member or a dedicated connection structure.

<Gas Collection Side Regulator Valve Unit>

The gas collection side regulator valve unit 15 adjusts the amount of the gas flowing toward the negative pressure generation unit 2A (or the amount of the gas collected from the collection holes 130), and/or adjusts the types of gas to be guided to the negative pressure generation unit 2A. The gas supply side regulator valve unit 3 and the gas collection side regulator valve unit 15 can independently control the amount of the gas supply and the amount of the gas collection, respectively.

As shown in FIG. 11B, the gas collection side regulator valve unit 15 includes a gas collection side input port part 150, an atmosphere open side input port part 151, and an output port part 152. The gas collection side input port part 150 is connected to the outlet tube portion 14B. The atmosphere open side input port part 151 is open to the atmosphere. The output port part 152 is connected to the input side of the negative pressure generation unit 2A (the suction side of the gas supply unit 2) via the filter unit 8. The gas collection side regulator valve unit 15 is controlled by the control unit 10 to open and close the gas collection side input port part 150 and the atmosphere open side input port part 151. For example, the gas collection side regulator valve unit 15 includes valves capable of electrical open and close controls, such as a solenoid valve. It is preferable that valves be configured so that the opening and closing ratio between the gas collection side input port part 150 and the atmosphere open side input port part 151 can be variably adjusted.

As described above, the outlet tube portion 14B is connected to the negative pressure generation unit 2A via the gas collection side regulator valve unit 15. This makes the inside of the outlet tube portion 14B and the collection side extended tube portion 14A negative in pressure.

<Negative Pressure Generation Unit>

The negative pressure generation unit 2A is constituted by the suction side of the blower in a broad sense (gas supply unit 2). The gas collection side tube unit 13 (outlet tube portion 14B) is connected to the negative pressure generation unit 2A, so that the gas collection side tube unit 13 (outlet tube portion 14B) is made negative in pressure by the suction force of the blower in a broad sense (gas supply unit 2). In the present embodiment, the gas collection side tube unit 13 (outlet tube portion 14B) is connected to the negative pressure generation unit 2A via the gas collection side regulator valve unit 15 and the filter unit 8.

<Disposition Unit>

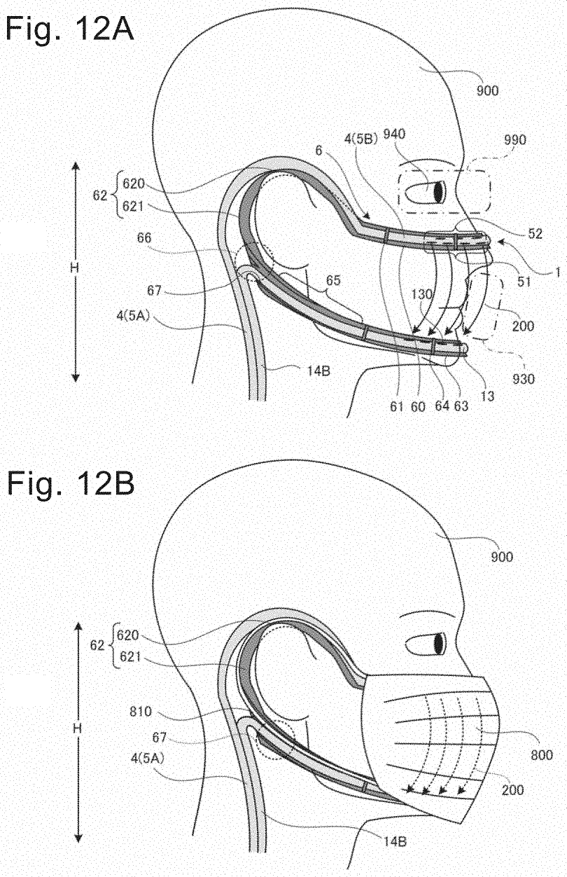

As shown in FIGS. 11B and 12A, the disposition unit 6 according to the present embodiment further includes a gas collection side frame portion 63, gas collection side attachment portions 64, collection-specific head fixing side frame portions 65, and connecting portions 66.

As shown in FIG. 11B, the gas collection side frame portion 63 is located below the mouth 920 of the user 900 to extend in the width direction W of the face of the user 900. The gas collection side attachment portions 64 are configured to attach the collection side extended tube portion 14A to the gas collection side frame portion 63 with the collection side extended tube portion 14A along the gas collection side frame portion 63. The gas collection side frame portion 63 thus locates the collection holes 130 of the collection side extended tube portion 14A in position.

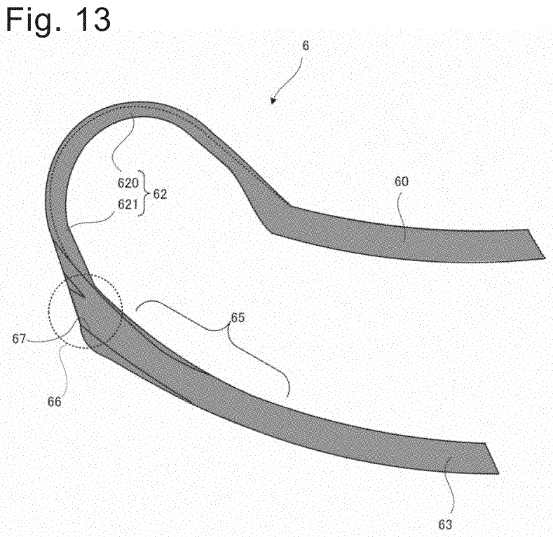

As shown in FIGS. 12A and 13, the collection-specific head fixing side frame portions 65 are continuous with the respective ends of the gas collection side frame portion 63, extend to the respective sides of the head of the user 900, and connect to the connection portions 66. More specifically, the collection-specific head fixing side frame portions 65 pass under the ears 950 of the user 900 from the front to behind the ears 950 of the user 900 and extend up to the rear of the ears 950. The connection portions 66 serve as an integral structure by connecting the (supply-specific) head fixing side frame portions 62 and the collection-specific head fixing side frame portions 65. Specifically, the connection portions 66 connect the bottom ends of the stopper portions 621 of the head fixing side frame portions 62 to the collection-specific head fixing side frame portions 65.

As shown in FIGS. 12A, 12B, and 13, the collection-specific head fixing side frame portion 65 on the right includes a tube portion side guide portion 67 configured to guide the outlet tube portion 14B. The tube portion side guide portion 67 is a groove, facing away from user 900, located along the outer surface of the collection-specific head fixing side frame portion 65. Note that the collection side extended tube portion 14A, together with the gas collection side frame portion 63, may be located on a frontal region of the head above the eyes 940 of the user 900 in the length direction H of the face (on the forehead) or below the chin of the user 900.

<Filter Unit>

The filter unit 8 according to the present embodiment is located on the gas collection side path (gas suction path). Some of viruses in the exhaled air collected by the gas collection side tube unit 13 are removed by the filter unit 8 before the exhaled air is released into the atmosphere.

<Control Unit>

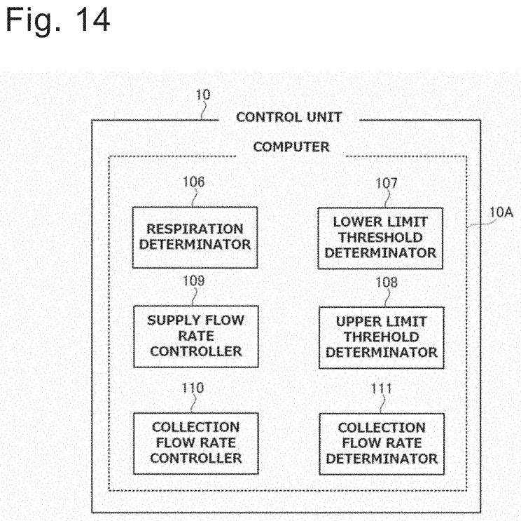

As shown in FIG. 14, the control unit 10 of the gas guide apparatus 1 according to the present embodiment further includes a collection flow rate controller 110 and a collection flow rate determinator 111. The collection flow rate controller 110 controls (adjusts) the flow rate of the gas collected from the collection holes 130. More specifically, the collection flow rate controller 110 controls to reduce the flow rate of the gas collected from the collection holes 130 if the lower limit threshold determinator 107 determines that the minimum pressure inside the mask 800 has fallen below the lower limit threshold S1. As a result, the minimum pressure inside the mask 800 increases to reach or exceed the lower limit threshold S1. Specifically, the collection flow rate controller 110 controls to reduce the amount of the gas collection by closing the gas collection side input port part 150 of the gas collection side regulator valve unit 15 and opening the atmosphere open side input port part 151 thereby adjusting the opening and closing ratio between the port parts 150 and 151, so that the negative pressure applied to the collection holes 130 decreases. The amount of the gas collection can also be reduced by reducing the fan rotation speed of the blower.

Moreover, the collection flow rate controller 110 controls to increase the flow rate of the gas collected from the collection holes 130 if the upper limit threshold determinator 108 determines that the maximum pressure inside the mask 800 exceeds the upper limit threshold S2. As a result, the maximum pressure inside the mask 800 falls to or below the upper limit threshold S2. Specifically, the collection flow rate controller 110 controls to increase the amount of the gas collection by opening the gas collection side input port part 150 of the gas collection side regulator valve unit 15 and closing the atmosphere open side input port part 151 thereby adjusting the opening and closing ratio between the port parts 150 and 151, so that the negative pressure applied to the collection holes 130 increases. The amount of the gas collection can also be increased by increasing the fan rotation speed of the blower. Note that if both the upper limit threshold determinator 108 and the lower limit threshold determinator 107 make the determination operations at the same time, preferably, priority is given to control by the lower limit threshold determinator 107.

Furthermore, the collection flow rate controller 110 can controls to increase the amount of the gas collection when the user 900 is breathing out, and reduce the amount of the gas collection when the user 900 is breathing in. The exhalation and inhalation of the user 900 are determined by the respiration determinator 106. Specifically, when the user 900 is breathing out, the collection flow rate controller 110 controls to positively collect the exhaled air from the collection holes 130 by opening the gas collection side input port part 150 and closing the atmosphere open side input port part 151 thereby adjusting the opening and closing ratio between the port parts 150 and 151. On the other hand, during inhalation, the collection flow rate controller 110 controls to direct fresh air from the atmosphere open side input port part 151 into the gas supply unit 2 (negative pressure generation unit 2A) by closing the gas collection side input port part 150 and opening the atmosphere open side input port part 151 thereby adjusting the opening and closing ratio between the port parts 150 and 151. Since the gas supplied to the user 900 during inhalation includes not only the circulating gas but also fresh air taken in from outside, the cooling effectiveness inside the mask 800 can be increased and the oxygen content of the gas can be maintained.

The gas collected by the gas collection side tube unit 13 is all filtered through the filter unit 8 before the gas is either released to the atmosphere from the atmosphere open side output port part 32 of the gas supply side regulator valve unit 3 or circulated into the mask 800 via the gas supply side tube unit 4. If the user himself/herself is infected with a virus or the like, viruses present in the exhaled air collected by the gas collection side tube unit 13 are removed by the filter unit 8 before the exhaled air is released into the atmosphere. This filtration can reduce virus diffusion to the surroundings.

The internal pressure of the mask 800 is determined by the ratio between the amount of the gas supply from the supply holes 50 and the amount of the gas collection from the collection hole 130. In the present embodiment, only the amount of the gas supply may therefore be controlled with the amount of the gas collection constant, or conversely, only the amount of the gas collection may be controlled with the amount of the gas supply constant. Both the amount of the gas supply and the amount of the gas collection may be controlled at the same time.

The collection flow rate determinator 111 determines the flow rate of the gas collected from the collection hole 130. For example, the collection flow rate determinator 111 calculates the flow rate of the gas collected from the collection hole 130 from the detection value of a not-shown flow rate sensor, the fan rotation speed of the blower in the gas supply unit 2, and the opening and closing ratios of the gas supply side regulator valve unit 3 and the gas collection side regulator valve unit 15, etc. The collection flow rate determinator 111 further derives a collection amount evaluation value for the gas in the mask 800 from the aforementioned values. If the collection amount evaluation value is determined to be lower than a predetermined lower limit threshold by the collection flow rate determinator 111, only the amount of the gas collection is increased while the internal pressure of the mask 800 is maintained within a predetermined range (control target values) by the collection flow rate controller 110. This gas collection increase is accomplished by increasing the fan rotation speed of the blower, opening the gas supply side output port part 31 of the gas supply side regulator valve unit 3, and/or opening the gas collection side input port part 150 of the gas collection side regulator valve unit 15, under the control of the collection flow rate controller 110.

On the other hand, if the collection amount evaluation value is determined to be higher than a predetermined upper limit threshold by the collection flow rate determinator 111, the amount of the gas collection is reduced while the internal pressure of the mask 800 is maintained within the predetermined range (control target values) by collection flow rate controller 110. This gas collection decrease is accomplished by reducing the fan rotation speed of the blower, closing the gas supply side output port part 31 of the gas supply side regulator valve unit 3, and/or closing the gas collection side input port part 150 of the gas collection side regulator valve unit 15, under the control of the collection flow rate controller 110. Note that the amount of the gas collection can also be adjusted on the basis of the user's instructions input from a not-shown input interface.

The greater the amount of the gas collection, the higher the performance for exhausting (collecting) the exhaled air in the mask 800 can be made. In view of maintaining the internal pressure of the mask 800 within the control target values, the amount of the gas supply is also increased as the amount of the gas collection increases. As a result, the cooling effectiveness inside of the mask 800 due to the introduction of outside air increases as well. This also leads to enhanced cleaning of the air inside the mask 800 and the space in front of the face.

The amount of the gas collection (may also be referred to as the amount of air circulation in the mask 800) is set to 20% or more (specifically, 4 L/min or more) of the instantaneous discharge flow rate of the exhaled air (typically, 20 to 30 L/min). The amount of the gas collection is preferably set to 50% or more (specifically, 10 L/min or more). The amount of the gas collection is more preferably set to 80% or more (specifically, 16 L/min or more). In the present embodiment, the amount of the gas collection is set to 20 L/min. With such a setting, most of the exhaled air can be quickly collected from the collection holes 130. This can collect viruses and the like in the exhaled air through the filter unit 8, and can thus reduce the amount of viruses leaking out of the mask 800.

<Detailed Description of Pressure Control and Flow Rate Control by Control Unit>

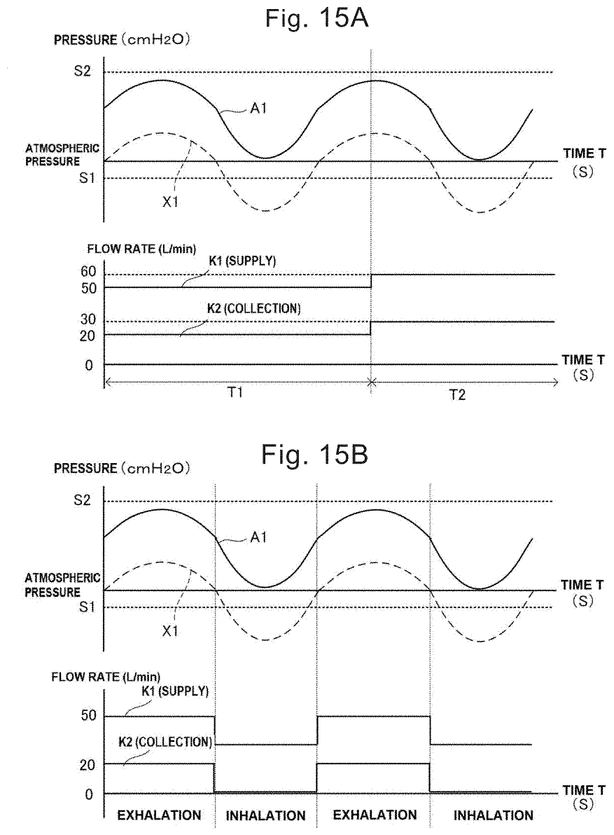

Next, control by the control unit 10 will be described with reference to FIGS. 15A to 17C. A solid line A1 in FIG. 15A represents an internal pressure variation model for the mask 800 in the steady state where the gas guide apparatus 1 is used. A dotted line X1 in FIG. 15A represents a pressure variation model with only the mask 800 on.

In the gas guide apparatus 1, the control unit 10 controls each part to supplies the gas from the supply holes 50 into the internal space of the mask 800 while collecting the gas from the collection holes 130. As indicated by a supply flow rate K1 in FIG. 15A, 50 L/min of the gas is supplied from the supply holes 50 in the time period T1, and 60 L/min of the gas is supplied from the supply holes 50 in the time period T2. As indicated by a collection flow rate K2, 20 L/min of the gas is collected from the collection holes 130 in the time period T1, and 30 L/min of the gas is collected from the collection holes 130 in the time period T2. As a result, substantially 30 L/min of the gas is supplied into the mask 800 in both the time periods T1 and T2, and the internal pressure of the mask 800 increases accordingly. Meanwhile, the air curtain 200 consisting of 20 L/min supply gas is formed in the mask 800 during the time period T1, and the air curtain 200 consisting of 30 L/min supply gas is formed in the mask 800 during the time period T2 (see FIGS. 12A and 12B). The flow rate of the air curtain 200 can be adjusted as appropriate by the collection flow rate controller 110 and the collection flow rate determinator 111.

The control unit 10 controls the amount of the gas supply to cause an internal pressure increase of 0.2 cmH₂O or more, preferably 0.4 cmH₂O or more, with reference to the pressure variation model X1 of FIG. 15A (see the dotted lines X1 in FIGS. 15A and 15B) (in other words, with reference to a state where the gas supply by the gas guide apparatus 1 is shut off, or is at an atmospheric pressure state).

In particular, the control unit 10 preferably controls the amount of the gas supply to increase the pressure and thus prevent the internal pressure of the mask 800 from becoming negative during respiration. While the mask 800 itself is unable to prevent the intrusion of viruses, maintaining the internal pressure of the mask 800 at positive pressure can suppress the intrusion of viruses through the main body of the mask 800 or gaps around.

To obtain the aforementioned range of the increase in the internal pressure, substantially 30 L/min to 60 L/min of the gas is preferably supplied from the supply holes 50 into the mask 800. In other words, the supply flow rate K1 and the collection flow rate K2 are set to have a difference of 30 L/min to 60 L/min.

While the internal pressure of the mask 800 during inhalation is maintained positive as in FIG. 15A, the inhalation resistance to the user wearing the mask 800 becomes substantially the same as that of no mask. This provides a comfortable feel during extended use. In addition, the formation of the air curtain 200 in the mask 800 enables efficient collection of the exhaled air of the user 900. As a result, viruses the user 900 emits through the exhaled air can be collected via the air curtain 200. The air curtain 200 also provides a secondary effect of reducing droplets such as saliva droplets emitted from the user 900.

The collection flow rate has been described to change at a given time. However, the control unit 10 may also preferably control the collection flow rate (flow rate of the air curtain 200) to decrease during inhalation time and control the collection flow rate (flow rate of the air curtain 200) to increase during exhalation time as shown in FIG. 15B. This can increase the collection efficiency only during exhalation. In FIG. 15B, the collection of the gas is stopped during inhalation time.

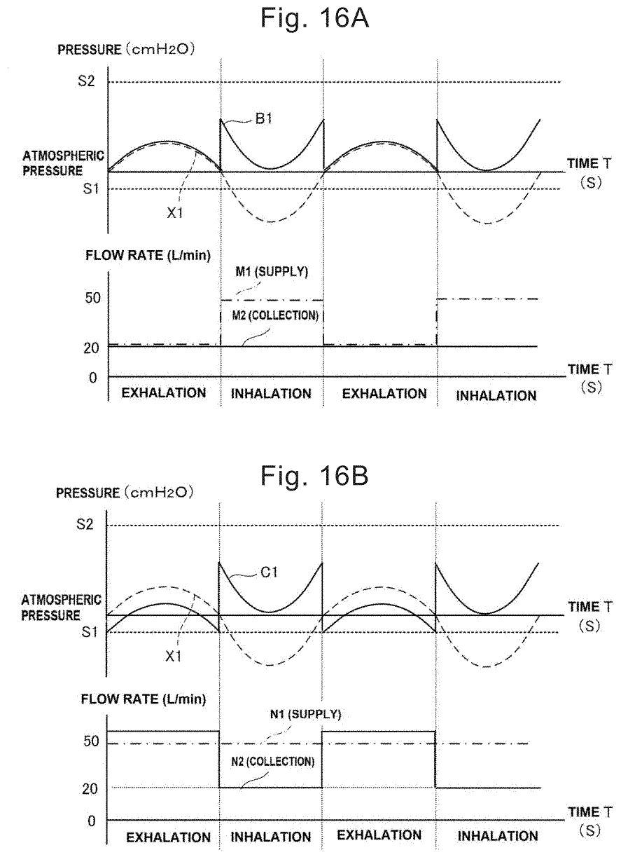

A solid line B1 in FIG. 16A represents a pressure variation model for the internal space of the mask 800 in the case where the gas guide apparatus 1 is used and control is exercised to increase exhalation collection efficiency. A dotted line X1 in FIG. 16A represents the pressure variation model with only the mask 800 on.

As shown by a dot dashed line M1 in FIG. 16A, 50 L/min of the gas is supplied from the supply holes 50 during inhalation time, and 20 L/min of the gas is supplied from the supply hole 50 during exhalation time. Meanwhile, as shown by a solid line M2, 20 L/min of the gas is collected from the collection holes 130 during both exhalation and inhalation times. Consequently, during inhalation time when the pressure inside the mask 800 is likely to become negative, substantially 30 L/min of the gas is supplied into the mask 800. This increases the internal pressure of the mask 800. By contrast, during exhalation time when the pressure inside the mask 800 is likely to be positive, substantially 0 L/min of the gas is supplied. This reduces the internal pressure, resulting in a similar state to when the user wears only the mask 800. Even during exhalation time, the exhaled air can be efficiently collected since the air curtain 200 consisting of 20 L/min supply gas is formed inside the mask 800.

In such a manner, the collection efficiency of the exhaled air can be increased by increasing the substantial amount of the gas supply (difference between the amount of the gas supply and the amount of the gas collection) during inhalation time to increase the internal pressure of the mask 800 and reducing the substantial amount of the gas supply during exhalation time to reduce the internal pressure of the mask 800 while maintaining a constant flow rate through the air curtain 200.

A solid line C1 in FIG. 16B represents a pressure variation model for the internal space of the mask 800, which is controlled to further increase the collection efficiency of the exhaled air compared to the pressure variation model of FIG. 16A. A dotted line X1 in FIG. 16B represents the pressure variation model with only the mask 800 on.

As shown by a dot dashed line N1 in FIG. 16B, 50 L/min of the gas is supplied from the supply holes 50 both during inhalation time and exhalation time. Meanwhile, as shown by a solid line N2, 60 L/min of the gas is collected from the collection holes 130 during exhalation time, and 20 L/min of the gas is collected from the collection holes 130 during inhalation time.

Consequently, during inhalation time when the pressure inside the mask 800 is likely to become negative, substantially 30 L/min of the gas is supplied into the mask 800. This increases the internal pressure of the mask 800 into a positive pressure. By contrast, during exhalation time when the pressure inside the mask 800 is likely to become positive, substantially −10 L/min of the gas is supplied (i.e., the gas is sucked). The internal pressure shifts to negative pressures due to decreased internal pressure compared to when the user 900 wears only the mask 800, and the exhaled air of the user 900 is efficiently collected. Even during the exhalation time, the exhaled air can be efficiently collected since the air curtain 200 is formed inside the mask 800.

For example, suppose that a user 900 who clearly is already infected with a virus lives a daily life in a clean atmospheric environment. In such a case, the control mode of FIG. 16B is used to reduce the internal pressure of the mask 800 during exhalation time while maintaining the collection flow rate, thereby positively suppressing the release of viruses from the user himself/herself into the atmosphere. Meanwhile, the control mode of FIG. 16B makes the internal pressure of the mask 800 positive during inhalation time, thereby minimizing the inhalation resistance to the user 900 to not tire the user 900.

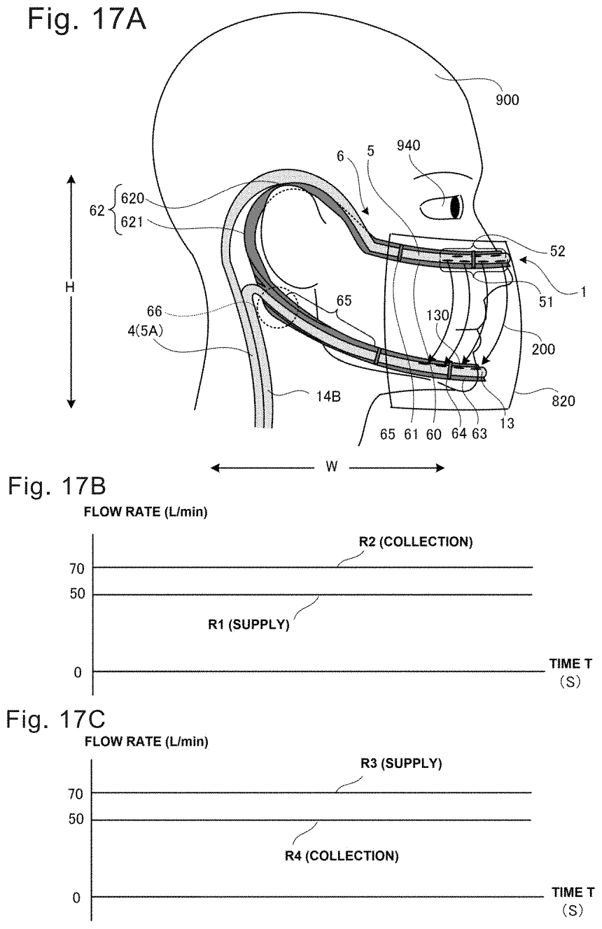

While the aforementioned description has dealt with the case of wearing the mask 800, the user 900 may wear the face guard 820 as in a modification shown in FIG. 17A. This can generate a high flow rate air curtain 200 inside the face guard 820. In such a case, 50 L/min of the gas is supplied from the supply holes 50 as shown by a solid line R1 in FIG. 17B, and 70 L/min of the gas is collected from the collection holes 130 as shown by a solid line R2. Setting the amount of the gas collection to be greater than the amount of the gas supply will not increase the respiration load to the user 900 since the face guard 820 is exposed to open air around the nose and mouth regions in an atmospheric pressure state. In addition, the over-suction state can positively collect the exhaled air of the user with the ambient atmosphere. The spread of viruses carried by the user 900 can thus be suppressed. The virus spread prevention effect of the air curtain 200 and the virus collection using the collection holes 130 can be implemented in a compatible manner even with the face guard 820 omitted.

Moreover, 70 L/min of the gas may be supplied from the supply holes 50 as shown by a solid line R3 in FIG. 17C while 50 L/min of the gas may be collected from the collection holes 130 as shown by a solid line R4. Setting the amount of the gas supply to be greater than the amount of the gas collection will not make the user 900 hard to breathe, since the face guard 820 is exposed to open air around the nose and mouth regions in an atmospheric pressure state. In addition, the over-supply state can repel viruses potentially entering from around the nose and mouth, whereby the user 900 is prevented from being infected with the viruses. The virus infection prevention effect of the air curtain 200 can also be obtained even with the face guard 820 omitted.

A mode where the amount of the gas collection is set to be greater than the amount of the gas supply as shown in FIG. 17B will be defined as an infected processing mode. A mode where the amount of the gas supply is set to be greater than the amount of the gas collection as shown in FIG. 17C will be defined as an uninfected processing mode. A mode related to other processing will be defined as a normal processing mode. The control unit 10 may include a (not-shown) mode switch unit that accepts a user input using the mode change switch of the operation interface 105 of the gas guide apparatus 1 and switches to one of the processing modes corresponding to the operation. The mode switch unit instructs the supply flow rate controller 109 and the collection flow rate controller 110 to perform processing in the processing mode corresponding to the accepted operation. The processing modes are not limited to the aforementioned three types, and other processing modes may be included. The switching control between the infected processing mode and the uninfected processing mode can also be applied to the gas guide apparatuses 1 of all the other embodiments where both the supply function and the collection function are used.

Incidentally, it is conceivable that pores in the main body of the mask 800 can be reduced in size to give the mask 800 a function of capturing viruses by itself. However, such a mask 800 is extremely expensive and not practical for everyday use with frequent replacement. Furthermore, the user would experience ventilation resistance of the mask 800 so high that the mask 800 would hinder daily life.

According to the present embodiment, the mask 800 and the face guard 820 are to be frequently replaced and can be configured to have only the effect of blocking droplets such as saliva droplets. Meanwhile, both viral infection of and viral spread from the user 900 himself/herself can be suppressed in a compatible manner by supplying a clean gas to the limited space inside the mask 800 or the face guard 820 and collecting and filtering the contaminated gas released from the user 900 as exhaled air.

### Fourth Embodiment

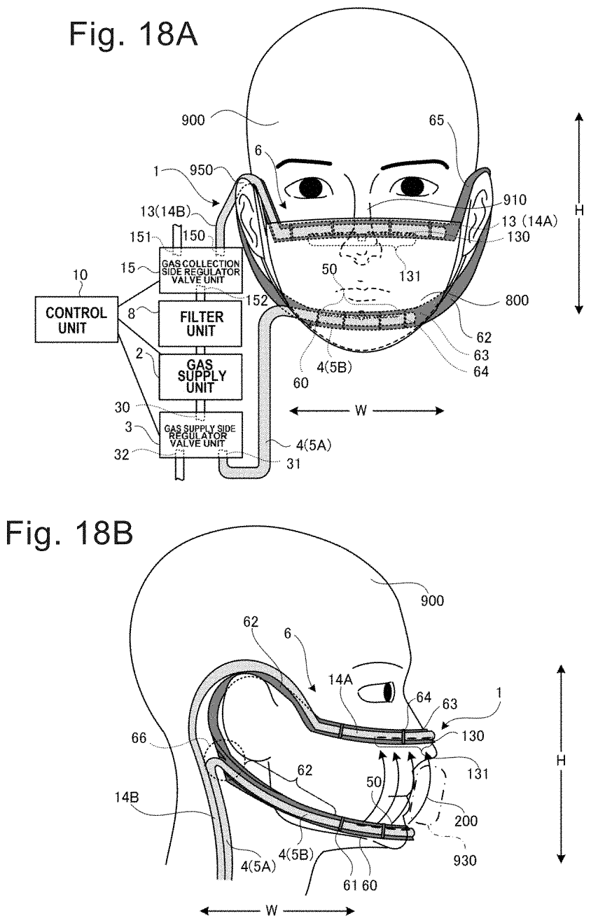

Next, a gas guide apparatus 1 according to a fourth embodiment of the present invention will be described with reference to FIGS. 18A and 18B. As shown in FIG. 18A, the gas guide apparatus 1 according to the present embodiment is worn on the face of a user 900 who wears a mask 800. The gas guide apparatus 1 according to the present embodiment has a similar structure to that of the gas guide apparatus 1 according to the first embodiment for the most part. Differences in structure will be described below.

As shown in FIGS. 18A and 18B, the gas supply side components and the gas collection side components of the gas guide apparatus 1 according to the present embodiment are reversed from those of the gas guide apparatus 1 according to the third embodiment of the present invention. Specifically, the extended tube portion 5B is disposed below the mouth 920 of the user 900 by the disposition unit 6. The collection side extended tube portion 14A is disposed over the dorsum of the nose 910 of the user 900 by the disposition unit 6. This can increase the internal pressure of the gas in the mask 800 and circulate the gas.

The collection side extended tube portion 14A may be located above the eyes 940 of the user 900 in the length direction H of the face (on the forehead). In such a case, the gas emitted from the supply holes 50 of the extended tube portion 5B passes through not only the mouth vicinity area 930 but also the eye vicinity area and is collected from the collection holes 130 if the mask 800 is detached and a face guard is adopted. With such a configuration, an air curtain 200 composed of a flow of air is formed in the eye vicinity area as well. Viruses flying toward the eyes 940 are therefore blown upward by the air curtain 200. This can prevent the viruses from getting into the eyes 940.

### Fifth Embodiment

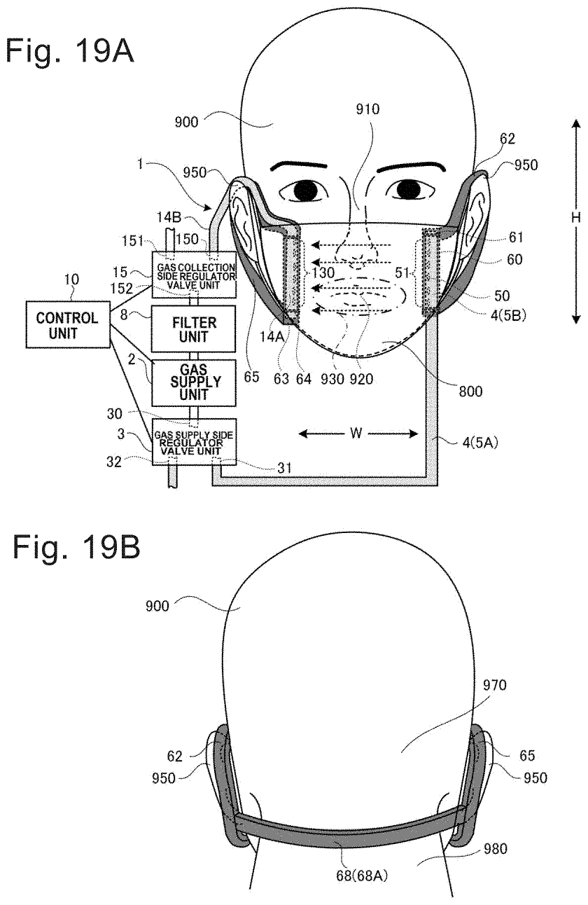

A gas guide apparatus 1 according to a fifth embodiment of the present invention will be described with reference to FIGS. 19A and 19B. As shown in FIGS. 19A and 19B, the gas guide apparatus 1 according to the present embodiment is worn on the face of a user 900 who wears a mask 800. The gas guide apparatus 1 according to the present embodiment has a similar structure to that of the gas guide apparatus 1 according to the first embodiment for the most part. Differences in structure will be described below.

In the present embodiment, as shown in FIG. 19A, both the extended tube portion 5B and the collection side extended tube portion 14A extend substantially in parallel with the length direction H of the face of the user 900. The first supply hole group 51 of the extended tube portion 5B and the collection hole group 131 of the collection side extended tube portion 14A are located on both outer sides of the mouth vicinity area 930 in the width direction W of the face of the user 900 and opposed to each other. As a result, the gas supplied from the gas supply unit 2 flows through the mouth vicinity area 930 in the width direction W of the face of the user 900.

As shown in FIG. 19A, the gas supply side frame portion 60 holding the extended tube portion 5B with the attachment portions 61 and the head fixing side frame portion 62 configured to fix the gas supply side frame portion 60 to the head are located on the side of one ear of the user 900. One end of the head fixing side frame portion 62 is continuous with one end of the gas supply side frame portion 60. The other end of the head fixing side frame portion 62 is continuous with the other end of the gas supply side frame portion 60. The head fixing side frame portion 62 extending from the one end of the gas supply side frame portion 60 passes over the ear 950 of the user 900 from the front to behind the ear 950. The head fixing side frame portion 62 turns around behind the ear 950, passes under the ear 950 from behind to the front of the ear 950, and is continuous with the other end of the gas supply side frame portion 60.

Similarly, the gas collection side frame portion 63 holding the collecting side extended tube portion 14A with the gas collection side attachment portions 64 and the collection-specific head fixing side frame portion 65 configured to fix the gas collection side frame portion 63 to the head are located on the side of the other ear of the user 900. One end of the collection-specific head fixing side frame portion 65 is continuous with one end of the gas collection side frame portion 63. The other end of the collection-specific head fixing side frame portion 65 is continuous with the other end of the gas collection side frame portion 63. The collection-specific head fixing side frame portion 65 extending from the one end of the gas collection side frame portion 63 passes over the ear 950 of the user 900 from the front to behind the ear 950. The collection-specific head fixing side frame portion 65 turns around behind the ear 950, passes under the ear 950 from behind to the front of the ear 950, and is continuous with the other end of the gas collection side frame portion 63.

As shown in FIG. 19B, the head fixing side frame portion 62 and the collection-specific head fixing side frame portion 65 may each be continuous with the bridge portion 68 described in the second embodiment (may be defined as a connection portion 68A). While the bridge portion 68 here is described to be located on the back of the head, the bridge portion 68 may be located on the dorsum of the nose or the chin of the face to connect the two frame portions 62 and 65. The gas supply side frame portion 60 and the head fixing side frame portion 62 may be either integrally formed or configured as respectively independent, interconnectable separate members. If both are separate members, they are connected by means of a connection. The connection means consists, for example, of an independent connection member or a dedicated connection structure. The gas collection side frame portion 63 and the collection-specific head fixing side frame portion 65 are also the same as the gas supply side frame portion 60 and the head fixing side frame portion 62. The head fixing side frame portion 62 and the collection-specific head fixing side frame portion 65 may be either integrally formed with the bridge portion 68 or configured as interconnectable separate components independent of the bridge portion 68. If both are separate members, they are connected by means of a connection. The connection means consists, for example, of an independent connection member or a dedicated connection structure.

The gas guide apparatus 1 according to the present embodiment passes the gas through the mouth vicinity area 930 in the width direction W of the face of the user 900. This can increase the internal pressure of the mask 800 and prevent the mask 800 from sticking to the face. The air curtain 200 can also be formed in the mouth vicinity area 930 even with the mask 800 off.

### Sixth Embodiment

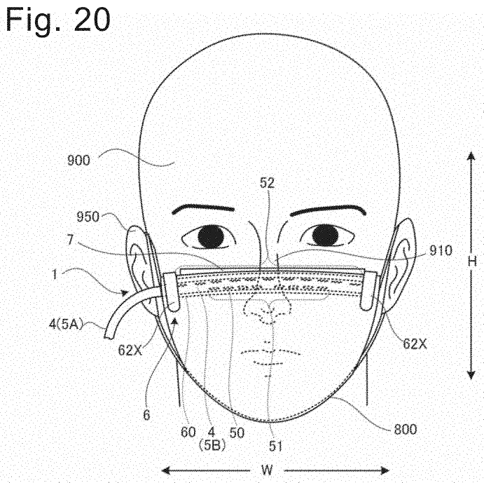

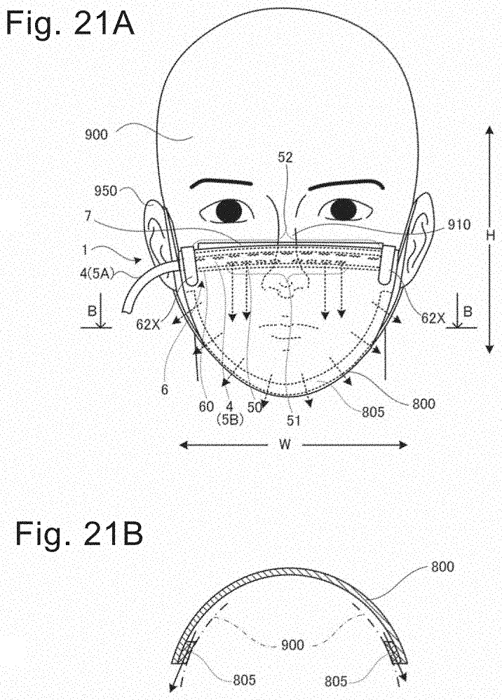

A gas guide apparatus 1 according to a sixth embodiment of the present invention will be described with reference to FIGS. 20 to 21B. The gas guide apparatus 1 according to the present embodiment has a similar structure to that of the gas guide apparatus 1 according to the first embodiment for the most part. Differences will thus be described below.

As shown in FIG. 20, the disposition unit 6 of the gas guide apparatus 1 includes detachable external fixing tools 62X like a clip. The disposition unit 6 itself is detachably attached to a cover member (external member), such as the mask 800 and a face guard, by pinching a peripheral edge of the cover member with the external fixing tools 62X. As a result, the disposition unit 6 is indirectly fixed to the head by the rubber ear straps of the mask 800 or a head fixing portion of the face guard device itself. The fixing method of the external fixing tools 62X is not limited to the pinching structure like a clip. Buttons, a hook-and-loop fastener, a double-sided tape, or other detachably attachable structures may be employed.

FIGS. 21A and 21B show a modification of the gas guide apparatus 1 according to the present embodiment. As in this modification, the mask 800 itself may also preferably have an air permeable portion 805. The air permeable portion 805 is interposed between the skin of the user 900 and the sheet member of the mask 800 in the vicinity of the peripheral edge of the sheet member of the mask 800, and releases the gas supplied from the supply holes 50 into the mask 800 to outside. Porous resin materials such as sponge and urethane foam, gathered cloth, nonwoven fabric, a three-dimensional resin mesh three-dimensionally molded in a thickness direction, a fiber mesh three-dimensionally woven in a thickness direction, or the like can be used for the air permeable portion 805. The peripheral edge of the mask 800 makes close contact with the skin of the user 900, and heat is therefore likely to be accumulated at the peripheral edge. In this modification, the air permeable portion 805 is thus formed at the contacting portion between the sheet member of the mask 800 and the skin. Body heat can be released by passing the gas through the air permeable portion 805 from inside to outside.

In the present embodiment, the mask 800 is preferably made of a water absorbing or hydrophilic material. When the user 900 wears the mask 800 moistened, the gas emitted from the supply holes 50 agitates the gas inside the mask 800, and the moisture in the mask 800 is vaporized by the airflow. The resulting heat of vaporization can cool the internal space of the mask 800. Meanwhile, the air permeable portion 805 is preferably made of a water repellent material. If the air permeable portion 805 is made of a water absorbing material, the moisture of the mask 800 is absorbed by the air permeable portion 805 in contact with the skin. This makes the skin wet all the time and roughens the skin. The water repellent material is intended to avoid such a trouble.

### Seventh Embodiment

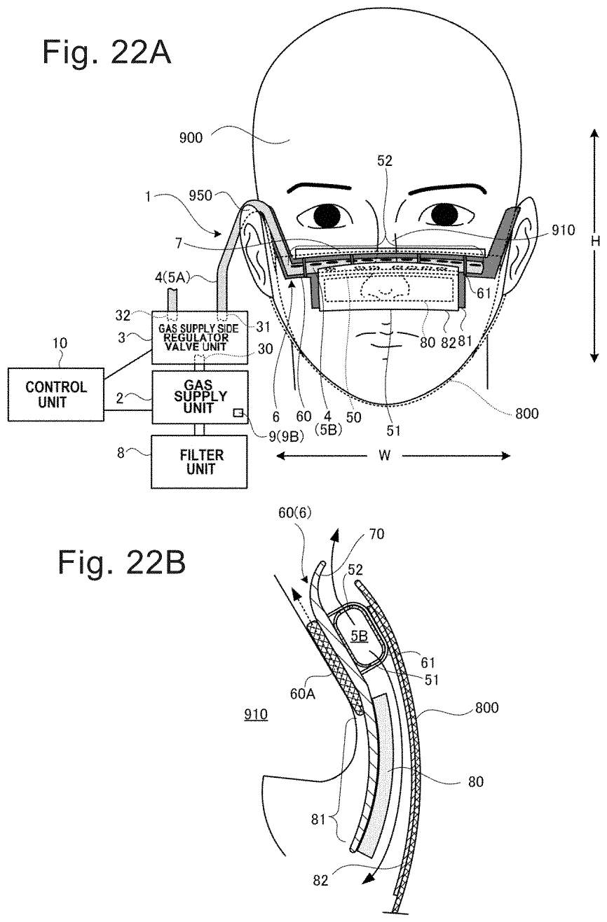

A gas guide apparatus 1 according to a seventh embodiment of the present invention will be described with reference to FIGS. 22A and 22B. The gas guide apparatus 1 according to the present embodiment has a similar structure to that of the gas guide apparatus 1 according to the first embodiment for the most part. Differences will thus be described below.

As shown in FIGS. 22A and 22B, the gas guide apparatus 1 includes a water absorbing member 80 that can retain moisture. The water absorbing member 80 has a sheet-like configuration, and can be made of a sponge or other porous material, nonwoven fabric, fibers, a water absorbing polymer, or the like. The disposition unit 6 includes a water absorbing member holding portion 81 configured to hold the water absorbing member 80. The water absorbing member holding portion 81 extends downward (toward the mouth) from the gas supply side frame portion 60 disposed over the dorsum of the nose of the user 900. As shown in FIG. 22A, the water absorbing member holding portion 81 holds the water absorbing member 80 so that the water absorbing member 80 extends downward (mouth side) from the extending tube portion 5B and extends in the width direction W of the face of the user 900. The water absorbing member 80 may be held by the water absorbing member holding portion 81 so that it covers part or all of the extended tube portion 5B. As a result, the water absorbing member 80 is positioned near the first supply hole group 51 of the extended tube portion 5B inside the mask 800. For example, the water absorbing member holding unit 81 can hold the water absorbing member 80 by using an adhesion structure such as a double-sided tape, a surface holding structure such as a hook-and-loop fastener, or a pinching structure such as a clip.

The water absorbing member holding unit 81 also serves as a face side separation member that is interposed between the water absorbing member 80 and the user 900 to separate the water absorbing member 80 from the user 900. This prevents the moisture of the water absorbing member 80 from being in contact with the skin of the user 900 all the time to roughen the skin.

The gas guide apparatus 1 further includes an outer side separation member 82 that is located on the opposite side of the water absorbing member 80 from the face of the user 900, i.e., on the mask 800 side to prevent the moisture of the water absorbing member 80 from moving to the mask 800. In other words, the outer side separation member 82 is located between the mask 800 and the water absorbing member 80 to prevent the mask 800 from getting wet. In the present embodiment, the outer side separation member 82 is a water repellent resin film, and covers the outer surface of the water absorbing member 80. The outer side separation member 82 is fixed to the gas supply side frame portion 60 of the disposition unit 6 or the extended tube portion 5B. The gas emitted from the first supply hole group 51 of the extended tube portion 5B passes through the gap between the outer surface of the water absorbing member 80 and the outer side separation member 82 to vaporize the moisture of the water absorbing member 80. The resulting heat of vaporization can cool the internal space of the mask 800. The face side separation member 81 and the outer side separation member 82 may have structures different from the foregoing. For example, the face side separation member 81 and the outer side separation member 82 may be made of resin-molded three-dimensional mesh sheets or the like to positively pass the gas while suppressing moisture movement.

Although not shown in the drawings, a water supply tank may be located on the disposition unit 6 or outside to replenish the water absorbing member 80 with water. The water can be conveyed from the water supply tank to the water absorbing member 80 by using a water supply tube, a water permeable material causing capillary action, and the like.

In the present embodiment, an atomization unit configured to atomize the water from the water supply tank may be located inside the mask 800. The water supply tank may be located outside the mask 800. The atomization unit may be either located instead of and at the position of the water absorbing member 80, or located at a different position from the water absorbing member 80. The internal space of the mask 800 can thus be filled with air containing a sufficient amount of moisture, whereby the throat of the user 900 can be moistened. An ultrasonic atomizer can be disposed as the atomization unit.

### Eighth Embodiment

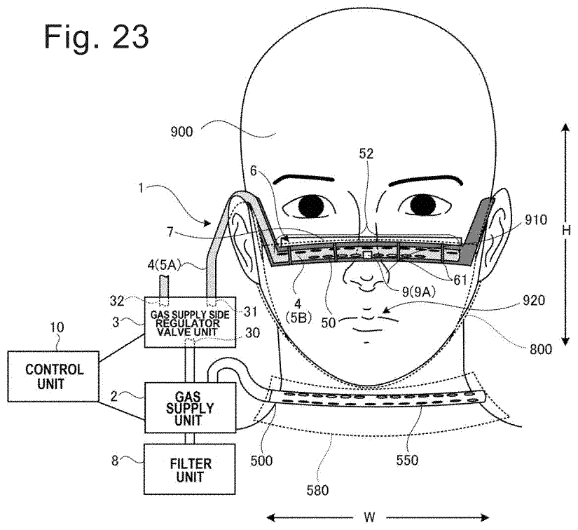

A gas guide apparatus 1 according to an eighth embodiment of the present invention will be described with reference to FIG. 23. The gas guide apparatus 1 according to the present embodiment has a similar structure to that of the gas guide apparatus 1 according to the first embodiment for the most part. Differences will thus be described below.

As shown in FIG. 23, the gas guide apparatus 1 includes a neck-specific gas supply side tube unit 500 configured to guide the gas supplied from the gas supply unit 2 to the neck of the user 900 or its vicinity. The neck-specific gas supply side tube unit 500 has neck side supply holes 550, which emit the gas to around the neck. In the present embodiment, the neck-specific gas supply side tube unit 500 is configured as an annular tube around the neck. However, the neck-specific gas supply side tube unit 500 may be located over a part of the periphery of the neck.

The gas guide apparatus 1 further includes a neck side water absorbing member 580 that is located around the neck and can retain water. In the present embodiment, the neck side water absorbing member 580 is an annular member made of cloth, nonwoven fabric, sponge, a water absorbing polymer, or the like. The neck side water absorbing member 580 is located around the neck to cover the outside of the neck side supply holes 550. The gas emitted from the neck side supply holes 550 is released to the outside through the inner peripheral surface of the neck side water absorbing member 580, and thus vaporizes the moisture of the neck side water absorbing member 580. The resulting heat of vaporization can cool the neck, areas where the cervical arteries run in particular. This can reduce the chance of heatstroke. The neck-specific gas supply side tube unit 500 and the neck side water absorbing member 580 may have structures and shapes different from the foregoing. While the case of guiding the gas to near the neck of the user 900 or its vicinity has been described here, the present invention is not limited thereto. The gas may be guided into clothes or a hat through tube piping to add a cooling effectiveness.

While the user 900 has been described to wear the mask 800 or the face guard 820, this is not restrictive. A cover member other than the mask 800 and the face guard 820 may be used. The cover member desirably has enough air permeability or openness for the user 900 to breathe freely even if the blower of the gas supply unit 2 stops. In other words, the cover member covers at least the mouth 920 of the user 900 to block droplets from the mouth 920 in an open state where the user 900 can breathe freely. There can be various sizes of cover members, like one with a size enough to cover the nose 910 and the mouth 920 of the user 900 and one with a size enough to cover the eyes 940, the nose 910, and the mouth 920 of the user 900. The cover member preferably has a size enough to cover at least the mouth 920, and more preferably at least the nose 910 and the mouth 920. The cover member blocks droplets from the mouth 920 of the user 900. In such a case, the cover member is attached to the gas guide apparatus 1 according to the present invention so that the nose 910 and the mouth 920 of the user 900 and the supply holes 50 are covered therewith. A structure capable of engagement with the cover member will be referred to as a cover member engagement structure. Cover member engagement structures include the mask engagement structure 11 and the face guard engagement structure 12.

### Ninth Embodiment

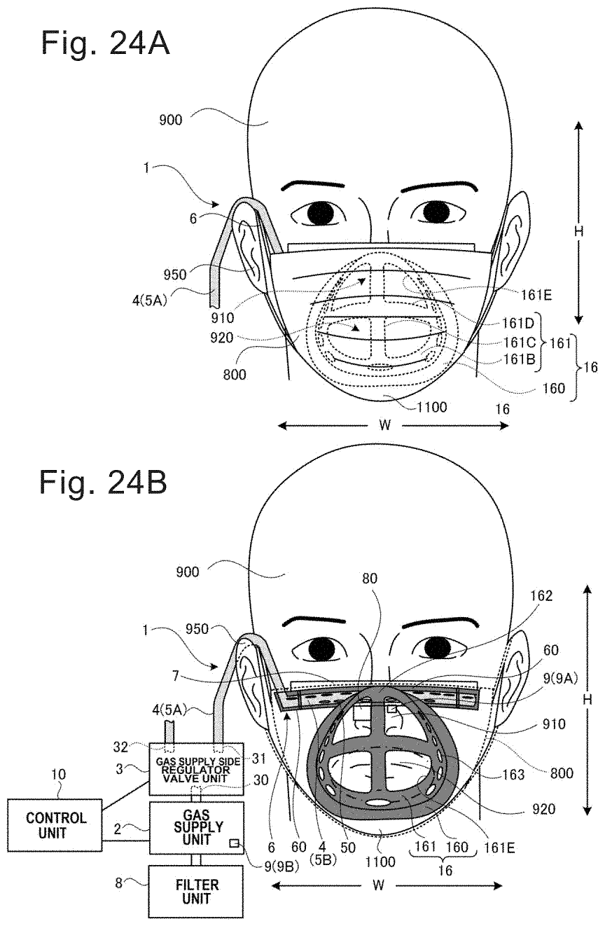

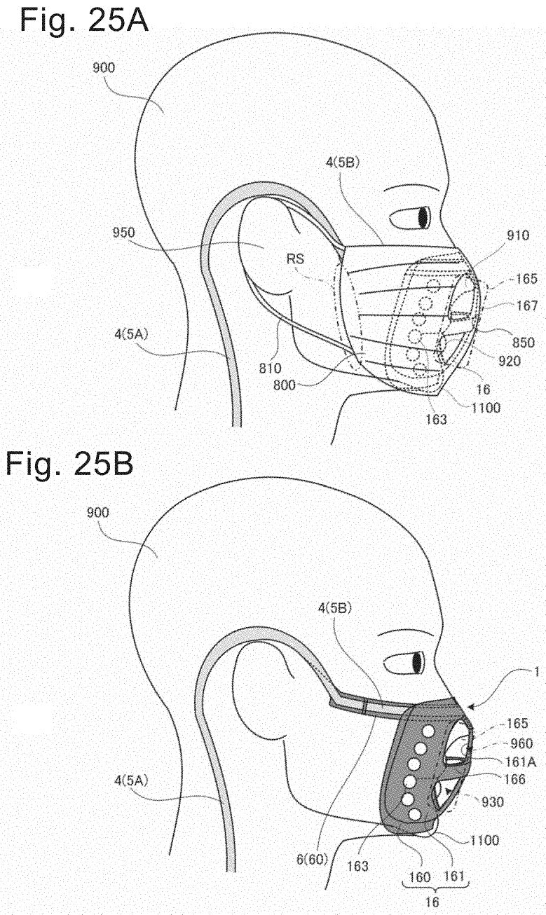

A gas guide apparatus 1 according to a ninth embodiment of the present invention will be described below with reference to FIGS. 24A to 26. Unlike the gas guide apparatus 1 according to the first embodiment, the gas guide apparatus 1 according to the present embodiment does not include the mask engagement structure 11 but a three-dimensional frame 16 between the mask 800 and the user 900 as shown in FIGS. 24A and 25A.

As shown in FIGS. 24B and 25B, the three-dimensional frame 16 includes an annular base portion 160 and a cover portion 161. When the user 900 wears the three-dimensional frame 16, the base portion 160 makes contact with a annular area surrounding the vicinity of the mouth 920 and the nose 910 of the user 900 and is positioned around the mouth 920 and the nose 910 of the user 900. The cover portion 161 protrudes from the base portion 160 convexly away from the mouth 920 and the nose 910 of the user 900 and covers the mouth 920 and the nose 910. As shown in FIG. 25B, an opposed surface 161A of the cover portion 161 opposite the mouth 920 and the nose 910 is convex away from the mouth 920 and the nose 910 of the user 900, whereby a sufficiently wide space 165 is formed between the opposed surface 161A and the mouth 920 and nose 910. In other words, the space 165 is formed in the front side of the area from the nose to the mouth of the user 900. When the user 900 wears the mask 800 over the three-dimensional frame 16, the mask 800 is thus deformed into a three-dimensional shape convex away from the mouth 920 of the user 900. This forms a sufficiently wide space 165 between the mask 800 and the mouth 920 and nose 910 of the user 900. In this sense, the three-dimensional frame 16 functions as a three-dimensional shape deformation unit for the mask 800. The space 165 includes at least part of the mouth vicinity area 930 and the nose vicinity area 960.

The cover portion 161 has vents 163 therethrough. A plurality of vents 163 are arranged along the length direction H of the face of the user 900 in areas of the cover portion 161 corresponding to both sides of the mouth 920 when the user 900 wears the three-dimensional frame 16. Vents 163 are also formed in an area of the cover portion 161 corresponding to between the mouth 920 and a chin 1100. Moreover, the center area of the cover portion 161 has openings (four vents 161E) greater than the vents 163 nearby.

As shown in FIG. 24A, the cover portion 161 includes an annular first frame piece 161B, a band-like second frame piece 161C, and a band-like third frame piece 161D. The first frame piece 161B has the vents 163 and surrounds the mouth 920 and the nose 910 of the user 900. The second and third frame pieces 161C and 161D are continuous with the first frame piece 161B and convex away from the mouth 920 of the user 900. The second frame piece 161C extends in the length direction of the face of the user 900. The third frame piece 161D extends in the width direction W of the face of the user 900. The second frame piece 161C and the third frame piece 161D intersect in front of the mouth 920 of the user 900. The cover portion 161 has openings on the left, right, top and bottom based on the center through which the second frame piece 161C and the third frame piece 161D pass. These four openings serve as the four vents 161E. The four vents 161E have an opening area greater than that of the vents 163. The space 165 is open to the outside through the vents 163 and 161E.

As shown in FIG. 25A, in the present embodiment, the user 900 wears the mask 800 over the three-dimensional frame 16 with the strap portions 810 of the mask 800 directly on the ears 950 of the user 900. As shown in FIG. 24B, the three-dimensional frame 16 includes a bridge portion 162 astride the dorsum of the nose, and is continuous with the gas supply side frame portion 60 at the bridge portion 162. The three-dimensional frame 16 is located on an inner surface 850 side of the mask 800 opposed to the user 900, and engaged with the inner surface 850 of the mask 800. The three-dimensional frame 16 is thereby positioned in the internal space of the mask 800 between the inner surface 850 of the mask 800 and the face of the user 900. With three-dimensional frame 16 positioned, the extended tube portion 5B is positioned to extend in the width direction W of the face of the user 900 and astride the dorsum of the nose 910 of the user 900. Here, the vents 163 are also positioned between the inner surface 850 of the mask 800 and the face of the user 900. In other words, the three-dimensional frame 16 can be regarded as constituting the disposition unit 6 in cooperation with the gas supply side frame portion 60. The three-dimensional frame 16 and the gas supply side frame portion 60 may be integrally formed or configured as respectively independent, separate members. In the case of separate members, the two should be connected by means of a connection. If both are separate members, they are connected by means of a connection. The connection means consists, for example, of an independent connection member or a dedicated connection structure. Alternatively, the three-dimensional frame 16 itself can be used as a gas supply side frame portion.

In this sense, the three-dimensional frame 16 functions as an engagement unit configured to position the disposition unit 6 to a predetermined position with respect to the mask 800. The three-dimensional frame 16 may be simply pressed against the face of the user 900 by the pressing force of the mask 800, and thereby positioned between the mask 800 and the user 900. The three-dimensional frame 16 may be fixed to the inner surface 850 side of the mask 800 by a fixing member such as a hook and a tape so that the three-dimensional frame 16 will not move from where it is positioned.

The gas supplied from the supply holes 50 of the extended tube portion 5B flows from the space 165 formed between the opposed surface 161A and the mouth 920 and nose 910 (including the mouth vicinity area 930 and the nose vicinity area 960) to both sides in the width direction W of the face of the user 900, downward in the length direction H of the face of the user 900, and toward the center area of the mask 800 through the surrounding vents 163 and the four openings (vents 161E). The gas is then discharged from the other edges of the mask 800 and the center area of the mask 800 to the outside. When the user 900 repeats breathing with the mask 800 on, the air in the aforementioned space 165 becomes hot. The configuration of the gas guide apparatus 1 according to the present embodiment can discharge the hot air to the outside while agitating the entire hot air with the gas supplied from the supply holes 50. The temperature in the space 165 can thereby be lowered. In particular, the three-dimensional frame 16 also forms small gaps near both cheeks covered by the mask 800 and near the ears. The gas supplied from the supply holes 50 can thus flow to both cheeks inside the mask 800 and agitate the air inside the mask 800, thereby efficiently lowering the heat inside the mask 800.

If the water absorbing member 80 (see FIGS. 22A and 22B) capable of containing moisture is located in or near the space 165, the heat inside the space 165 is absorbed by the moisture and released to the outside as heat of vaporization. The water absorbing member 80 is made of a material capable of absorbing moisture. Examples of the material capable of absorbing moisture include cloth, nonwoven fabric, and sponge. The water absorbing member 80 may therefore be constituted by a mask 800 made of cloth or nonwoven fabric, for example. The water absorbing member 80 may be constituted by a piece of cloth, nonwoven fabric, sponge, or the like additionally disposed on the three-dimensional frame 16.

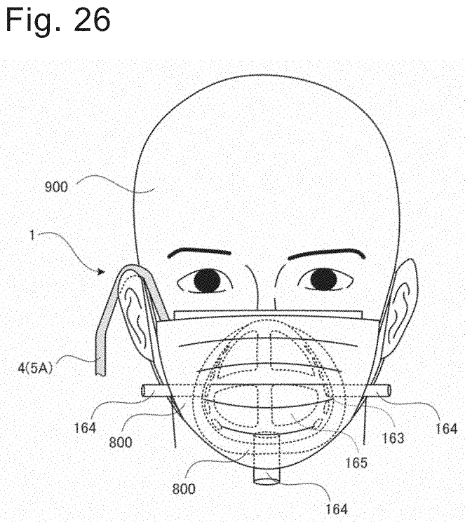

When the mask 800 is worn on the face of the user 900, the mask 800 typically makes close contact with the face at and near both ends of the mask 800 in the width direction. The air between the mask 800 and the face can thus be difficult to discharge to the outside from both ends of the mask 800 in the width direction. To reliably discharge the air to the outside, the three-dimensional frame 16 preferably includes exhaust pipes 164 extending from portions corresponding to vents 163 to outside the mask 800 as shown in FIG. 26. The air in the aforementioned space 165 can thereby be reliably discharged to the outside regardless of the degree of close contact between both ends of the mask 800 in the width direction W of the face of the user 900 and the face. The exhaust pipes 164 do not necessarily need to be made negative in pressure inside by a negative pressure generation unit as in other embodiments, and may be simply disposed so that the outer openings of the exhaust pipes 164 are open to the external space. In such a case, the air in the internal space of the mask 800 is naturally exhausted out via the exhaust pipes 164.

When the user 900 wears the mask 800 over the three-dimensional frame 16 as shown in FIG. 25A, the mask 800 is deformed along an outer surface 167 of the three-dimensional frame 16 into a three-dimensional shape convex away from the face of the user 900. Here, if the center area of the mask 800 is deformed away from the face of the user 900, both ends of the mask 800 in the width direction and their vicinities moves away from the face of the user 900. This can form a gap between both ends of the mask 800 in the width direction (see a double-dotted dashed line area RS in FIG. 25A) and the face of the user 900, or reduce the degree of close contact between the two. The gap and the degree of close contact can be adjusted by the shape of the three-dimensional frame 16. If the three-dimensional frame 16 is shaped to form the gap, the gas supplied from the supply holes 50 can flow into the gap and agitate the air without the exhaust pipes 164. The agitated air can be reliably discharged to the outside through the surface and the peripheral edges of the mask 800. The gap can be formed without a particular problem since the air discharged from the gap blows off viruses intruding from outside.

The three-dimensional frame 16 is preferably made of a resin, and more preferably a flexible resin in particular.

### Tenth Embodiment

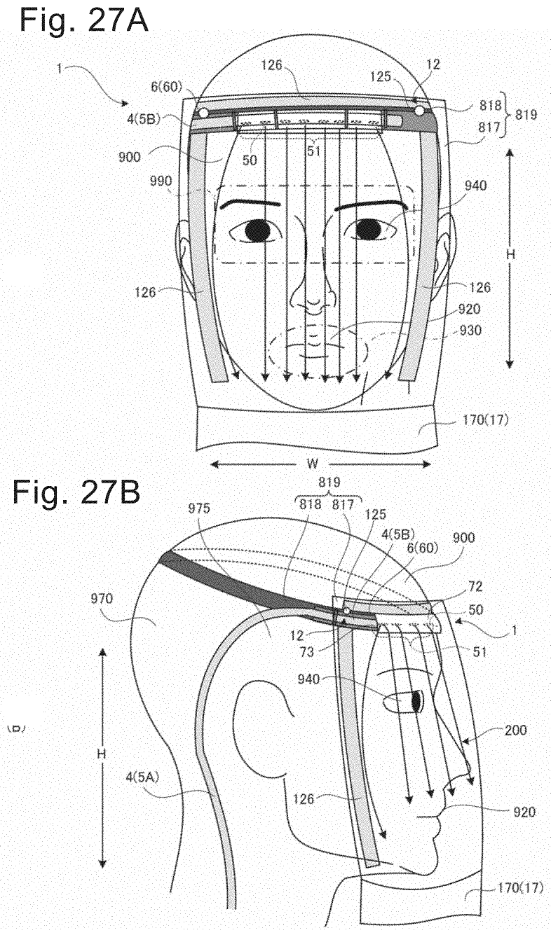

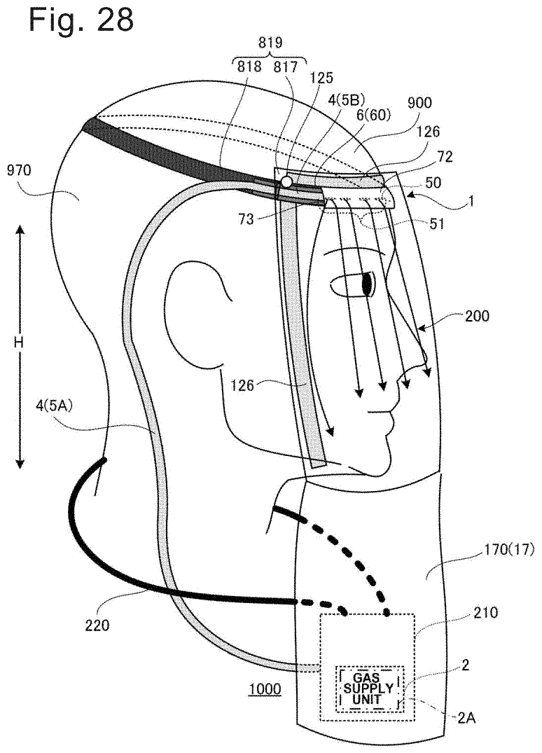

A gas guide apparatus 1 according to a tenth embodiment of the present invention will be described below with reference to FIGS. 27A to 28. The gas guide apparatus 1 according to the present embodiment is based on the modification of the gas guide apparatus 1 according to the first embodiment. In the modification of the gas guide apparatus 1 according to the first embodiment, the face guard 819 is fixed to the disposition unit 6. The present embodiment differs in that the disposition unit 6 or the extended tube portion 5B is fixed to the face guard 819.

As shown in FIGS. 27A and 27B, the face guard 819 includes a transparent resin plate 817 and a band-shaped attachment band unit 818 configured to attach the transparent resin plate 817 to the head of the user 900. The transparent resin plate 817 covers the front of the face. The transparent resin plate 817 is fixed to the attachment band unit 818 near its upper end. The attachment band unit 818 is attached to the user 900 by making contact with the head of the user 900 around the head of the user 900 and being moderately fastened around the head.

The gas supply side frame portion 60 (disposition unit 6) and the extended tube portion 5B are fixed to the face guard 819 via the face guard engagement structure 12. As shown in FIGS. 27A and 27B, the face guard engagement structure 12 according to the present embodiment includes face guard fixing portions 125 configured to fix the gas supply side frame portion 60 (disposition unit 6) to the attachment band unit 818. In other embodiments, the face guard 819 is fixed to the gas supply side frame portion 60 (disposition unit 6). In the present embodiment, the gas supply side frame portion 60 (disposition unit 6) is fixed to the face guard 819 (attachment band unit 818) by the face guard fixing portions 125. Specifically, the gas supply side frame portion 60 and the attachment band unit 818 are overlapped, and the gas supply side frame portion 60 is fixed to the attachment band unit 818 by the face guard fixing portions 125. Instead of the gas supply side frame portion 60, the extended tube portion 5B may be directly fixed to the attachment band unit 818 by the face guard fixing portions 125. In such a case, the attachment band unit 818 may be regarded as providing a similar function to that of the gas supply side frame portion 60 and constituting the disposition unit 6.

The face guard fixing portions 125 may have any configuration as long as the gas supply side frame portion 60 (disposition unit 6) or the extended tube portion 5B can be fixed to the attachment band unit 818.

In the present embodiment, as shown in FIGS. 27A and 27B, two cushioning portions 126 are located at or near peripheral edges on both ends of the transparent resin plate 817 in the width direction. The cushioning portions 126 extend in the length direction of the transparent resin plate 817 (in parallel with the length direction of the face of the user 900). When the user 900 wears the face guard 819, the two cushioning portions 126 make contact with the face of the user 900 at both sides in the width direction W of the face. A gap between the face of the user 900 and the transparent resin plate 817 is thus filled with and closed by the two cushioning portions 126. By contrast, there is no cushioning portion 126 at the lower peripheral edge of the transparent resin plate 817, and the lower peripheral edge of the transparent resin plate 817 is open to the outside. The gap between the lower peripheral edge of the transparent resin plate 817 open to the outside and the user 900 functions as an exhaust hole for discharging the air between the transparent resin plate 817 and the face of the user 900 to the outside. The gas supplied from the supply holes 50 toward both sides of the face of the user 900 is therefore reflected by the cushioning portions 126 and directed downward in the length direction of the face of the user 900. In other words, the cushioning portions 126 guide the gas supplied from the supply holes 50 downward in the length direction of the face of the user 900.

There is another cushioning portion 126 above the extended tube portion 5B in the length direction H of the face of the user 900. This cushioning portion 126 extends in the width direction W of the face of the user 900, and fills and closes the gap between the transparent resin plate 817 and the face of the user 900 on the upper side in the length direction H of the face of the user 900. As a result, the gas flowing to the upper side of the face of the user 900 is blocked by the cushioning portion 126.

The cushioning portions 126 are preferably made of a soft material since the cushioning portions 126 touch the face of the user 900. Examples of the soft material include air impermeable materials such as silicone and rubber. The soft material is preferably flexible because deformation along the face of the user 900 is preferable in terms of eliminating the gaps.

Other examples of the soft material may include air permeable materials such as sponge. If the cushioning portions 126 are made of an air permeable material, some of the air between the transparent resin plate 817 and the user 900 is released to the outside through the cushioning portions 126. This gives the user 900 a cool feel at the sides of the face since the air passes beside the face of the user 900.

The gas guide apparatus 1 according to the present embodiment includes a duct unit 17. The duct unit 17 is intended for the gas supply unit 2 to collect the air between the transparent resin plate 817 and the face of the user 900. The duct unit 17 guides the air between the transparent resin plate 817 and the face of the user 900 to the gas supply unit 2. At least part of the lower peripheral edge of the transparent resin plate 817 is connected to the gas supply unit 2 via the duct unit 17.

In the present embodiment, the duct unit 17 is made of a sheet member 170. The top end of the sheet member 170 or its vicinity is connected to the transparent resin plate 817 at or near the lower peripheral edge of the transparent resin plate 817. The sheet member 170 is extended to the gas supply unit 2 to cover the gas supply unit 2. As shown in FIG. 28, the gas supply unit 2 is located between the sheet member 170 and the body 1000 of the user 900. As a result, a path functioning as a duct configured to guide the air between the transparent resin plate 817 and the face of the user 900 to the gas supply unit 2 is formed between the sheet member 170 and the body 1000 of the user 900. In other words, the sheet member 170 and the body 1000 of the user 900 constitute a path functioning as a duct in a cooperative manner. That is, the body (duct) 1000 plays a role of the gas collection side tube unit 13.

In FIG. 28, the gas supply unit 2 is accommodated in a casing 210 hanging on a strap 220 around the neck of the user 900. The casing 210 also accommodates the gas collection side regulator valve unit 15, the filter unit 8, the gas supply side regulator valve unit 3, and the control unit 10 as shown in FIG. 11. The casing 210 is preferably as small in size so as to be able to put in a shirt chest pocket of the user 900.

The sheet member 170 may be made of either a deformable material such as cloth and a film, or a nondeformable material.

The duct unit 17 configured as described above is a so-called simplified duct constituted by cooperation of the sheet member 170 and the body of the user 900. However, this is not restrictive, and the duct unit 17 may be made of a tube that can constitute a duct by itself.

### Modification of Tenth Embodiment

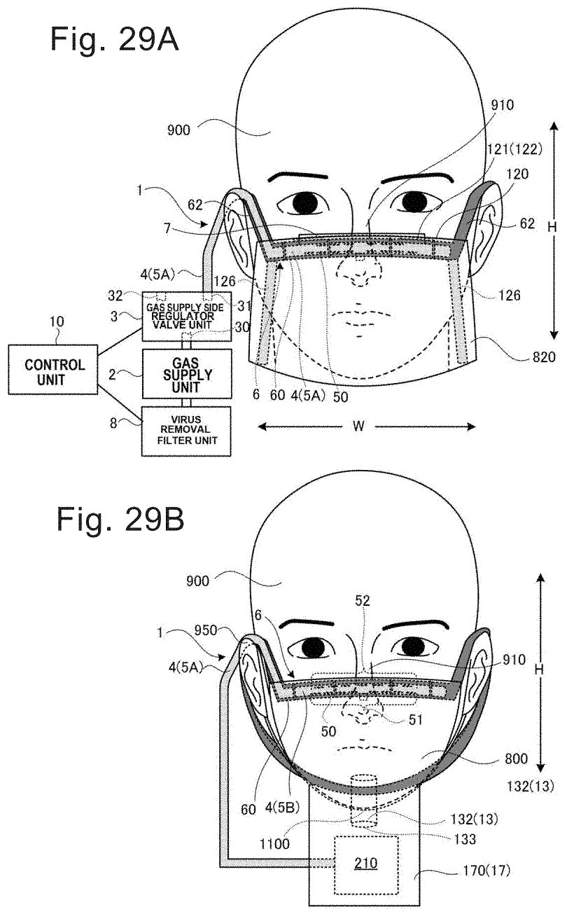

The cushioning portions 126 according to the present embodiment can also be employed for other embodiments. For example, as shown in FIG. 29A, the cushioning portions 126 can be applied to the face guard 820 of the type according to the second embodiment. As shown in FIG. 29B, the gas collection side tube unit 13 according to the third embodiment may be constituted by a tube 132 extending from a given position between under the mouth 920 of the user 900 and the chin 1100 to below the chin 1100. In such a case, for example, an exhaust port 133 of the tube 132 constituting the gas collection side tube unit 13 is located inside the duct unit 17 connecting at least part of the lower peripheral edge of the mask 800 to the gas supply unit 2.

### Eleventh Embodiment

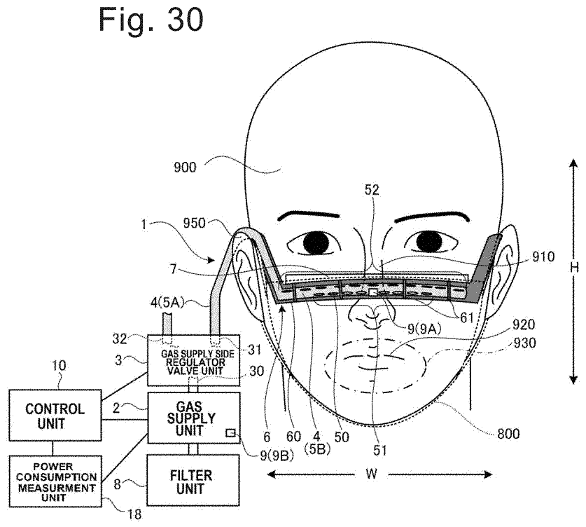

A gas guide apparatus 1 according to an eleventh embodiment of the present invention will be described below with reference to FIG. 30. The gas guide apparatus 1 according to the present embodiment is different from the other embodiments in the configuration of the pressure measurement unit 9. In the present embodiment, the gas supply unit 2 includes a blower. The blower refers to one in a broad sense, and it will be understood that a compressor is also included.

In the other embodiments, the pressure measurement unit 9 directly measures the pressure in front of the nose 910 or the mouth 920 of the user 900, and the control unit 10 controls the flow rate of the blower on the basis of the magnitude of the measurement value. In the present embodiment, the pressure measurement unit 9 does not directly measure the pressure in front of the nose 910 or the mouth 920 of the user 900, and the control unit 10 controls the flow rate of the gas sent by the blower on the basis of the power consumption of the blower.

If the pressure in front of the nose 910 or the mouth 920 of the user 900 is high, not much gas can be supplied through the supply holes 50 of the extended tube portion 5B. As a result, the flow rate of the gas sent by the blower inevitably decreases and the power consumption of the blower decreases. On the other hand, if the pressure in front of the nose 910 or the mouth 920 of the user 900 is low, a lot of the gas can be supplied through the supply holes 50 of the extended tube portion 5B. As a result, the flow rate of the gas sent by the blower increases and the power consumption of the blower increases. According to this principle, the pressure in front of the nose 910 or the mouth 920 of the user 900 is considered to be high if the power consumption of the blower is high. The pressure in front of the nose 910 or the mouth 920 of the user 900 is considered to be low if the power consumption of the blower is low.

In the present embodiment, the control unit 10 indirectly predicts the pressure state in front of the nose 910 or the mouth 920 of the user 900 on the basis of the value of the power consumption of the blower, and controls the flow rate of the gas sent by the blower. Specifically, the control unit 10 reduces the flow rate of the gas sent by the blower if the pressure in front of the nose 910 or the mouth 920 of the user 900 is high. The control unit 10 increases the flow rate of the gas sent by the blower in the other case.

As shown in FIG. 30, the gas guide apparatus 1 according to the present embodiment described above includes a power consumption measurement unit 18 configured to measure the power consumption of the blower. Like the first embodiment, the control unit 10 includes the respiration determinator 106, the lower limit threshold determinator 107, the upper limit threshold determinator 108, and the supply flow rate controller 109 (see FIG. 4). In the present embodiment, the lower limit threshold determinator 107, the upper limit threshold determinator 108, and the supply flow rate controller 109 operate on the basis of the measurement result obtained by the power consumption measurement unit 18.

The measurement result obtained by the power consumption measurement unit 18 can be regarded as the measurement result obtained by the pressure measurement unit 9 if the relationship between the power consumption of the blower and the pressure in front of the nose 910 or the mouth 920 of the user 900 has been determined by measurement and a function or a conversion table for converting the power consumption of the blower into the pressure has been derived in advance. The pressure evaluation value and the lower limit threshold S1 of the lower limit threshold determinator 107, and the pressure evaluation value and the upper limit threshold S2 of the upper limit threshold determinator 108, can therefore be paraphrased with power consumption-related values obtained by converting the respective pressure-related values determined in the first embodiment into power consumption of the blower.

More specifically, the lower limit threshold determinator 107 determines whether the evaluation value calculated by using the power consumption of the blower measured by the power consumption measurement unit 18 falls below the lower limit threshold S1. The upper limit threshold determinator 108 determines whether the evaluation value calculated by using the power consumption of the blower measured by the power consumption measurement unit 18 exceeds the upper limit threshold S2. The supply flow rate controller 109 controls to increases the flow rate of the gas supplied from the supply holes 50 if the lower limit determination unit 107 determines that the aforementioned evaluation value falls below the lower limit threshold S1. The supply flow rate controller 109 controls to reduce the flow rate of the gas supplied from the supply holes 50 if the upper limit threshold determinator 108 determines that the evaluation value exceeds the upper limit threshold S2. Note that the supply flow rate controller 109 can remove the effects of increases and decreases in the power consumption of the blower irrelevant to respiration by referring to the determination result of the respiration determinator 106, as noise. The evaluation value, the lower limit threshold S1, and the upper limit threshold S2 may be ones related to power consumption, or ones obtained by converting power consumption into pressure using the above-mentioned function, conversion table, or the like.

### Twelfth Embodiment

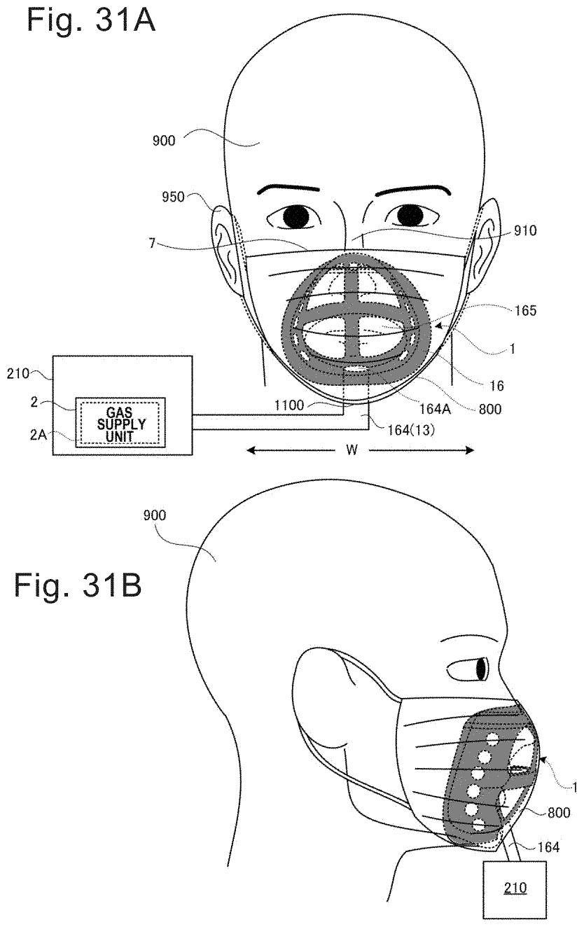

A gas guide apparatus 1 according to a twelfth embodiment of the present invention will be described below with reference to FIGS. 31A and 31B. As shown in FIGS. 31A and 31B, unlike the gas guide apparatuses 1 according to the other embodiments, the gas guide apparatus 1 according to the present embodiment does not include the gas supply side tube unit 4 but includes only the gas collection side tube unit 13 instead. More specifically, in the other embodiments, the gas guide apparatus 1 functions as a gas supply apparatus configured to supply a gas to the user 900 or a gas introduction apparatus configured to introduce a gas to the user 900. By contrast, the gas guide apparatus 1 according to the present embodiment functions as a gas collection apparatus configured to collect a gas from the user 900 or a gas emission apparatus configured to emit a gas near the user 900 to the outside.

The gas guide apparatus 1 according to the present embodiment is based on the gas guide apparatus 1 according to the ninth embodiment, from which the components configured to supply a gas are removed. The gas guide apparatus 1 according to the present embodiment includes the disposition unit 6, the gas collection side tube unit 13, and the negative pressure generation unit 2A.

The disposition unit 6 is constituted by the three-dimensional frame 16. Since the three-dimensional frame 16 has been described in conjunction with the gas guide apparatus 1 according to the ninth embodiment, a description thereof will be omitted. The gas collection side tube unit 13 is constituted by an exhaust tube 164. The exhaust tube 164 is disposed by the three-dimensional frame 16 so that the space 165 formed by the three-dimensional frame 16 communicates with the space outside the mask 800. More specifically, the exhaust pipe 164 is disposed by the three-dimensional frame 16 so that its own internal space is connected to the space 165 near the face of the user 900 and an outlet opening is in the space outside the mask 800. The exhaust tube 164 is disposed so that an inlet opening (exhaust hole 164A) of the exhaust tube 164 is located in the space 165 near the face of the user 900. As a result, the internal space of the exhaust pipe 164 is opened to the space 165 through the exhaust hole 164A.

In the present embodiment, the exhaust tube 164 extends from a lower part of the three-dimensional frame 16 constituting the portion below the mouth 920 of the user 900 to below the chin 1100. The exhaust tube 164 is connected to the negative pressure generation unit 2A. The three-dimensional frame 16 and the exhaust pipe 164 may be either integrally formed or configured as respectively independent, separate members.

The negative pressure generation unit 2A makes the inside of the exhaust tube 164 negative in pressure. In the present embodiment, the negative pressure generation unit 2A is implemented by the gas supply unit 2 accommodated in the casing 210. Like the tenth embodiment, the casing 210 also accommodates the gas collection side regulator valve unit 15, the filter unit 8, the gas supply side regulator valve unit 3, and the control unit 10 aside from the gas supply unit 2 serving also as the negative pressure generation unit 2A. The air in the space 165 formed by the three-dimensional fame 16 is thereby always emitted to the outside. In the present embodiment, the presence of the three-dimensional frame 16 provides a wide space in the mask 800 despite the gas in the mask 800 being positively exhausted to the outside. The user therefore will not get an uncomfortable feel. Moreover, since the outside air can be positively taken into the mask 800 via the mask 800, the internal space can always be maintained in a cool state.

### Modification of Twelfth Embodiment

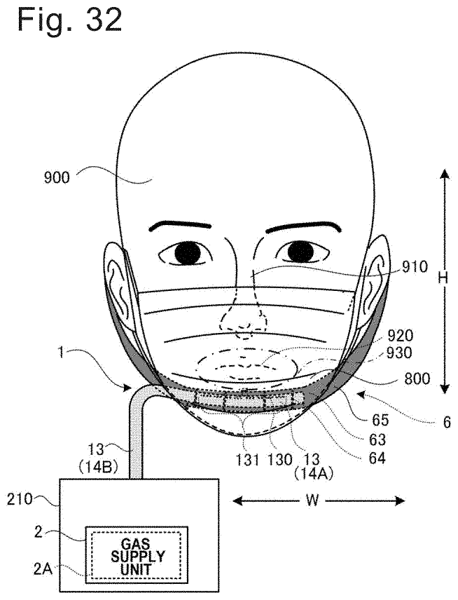

FIG. 32 shows a modification of the gas guide apparatus 1 according to the present embodiment. This modification is based on the gas guide apparatus 1 according to the third embodiment, from which the components configured to supply a gas are removed. In the gas guide apparatus 1 according to the modification, the collection side extended tube portion 14A of the gas collection side tube unit 13 is located on the face of the user 900 (for example, between under the mouth and the chin of the user 900) in parallel with the width direction W of the face of the user 900. Here, the plurality of collection holes 130 of the collection side extended tube portion 14A are arranged in a row in the width direction W of the face of the user 900 near the face of the user 900. One end of the outlet tube portion 14B of the gas collection side tube unit 13 is continuous with the collection side extended tube portion 14A. The other is connected to the negative pressure generation unit 2A (implemented by the gas supply unit 2). This makes the inside of the collection side extended tube portion 14A and the outlet tube portion 14B negative in pressure. The air in the internal space of the mask 800 is thereby always emitted to the outside.

The gas guide apparatuses 1 according to the present embodiment and the modification without the negative pressure generation unit 2A are also included in the scope of the present invention. Specifically, the inside of the exhaust tube 164 or the outlet tube portion 14B does not necessarily need to be made negative in pressure by the negative pressure generation unit as in other embodiments. Instead, the opening of the exhaust tube 164 or the outlet tube portion 14B outside the mask 800 may be simply located open to the external space. In such a case, the air in the internal space of the mask 800 is naturally released to the outside through the exhaust tube 164 or the outlet tube portion 14B.

### Thirteenth Embodiment

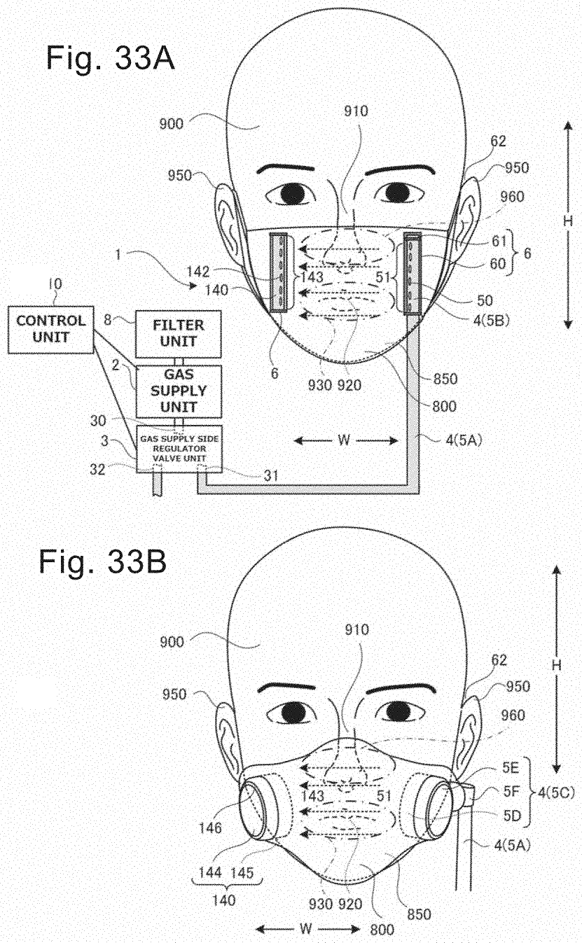

A gas guide apparatus 1 according to a thirteenth embodiment of the present invention will be described with reference to FIG. 33. As shown in FIG. 33A, the gas guide apparatus 1 according to the present embodiment is worn on a mask 800. The gas guide apparatus 1 according to the present embodiment has a similar structure to that of the gas guide apparatus 1 according to the first embodiment for the most part. Differences in structure will be described below.

In the present embodiment, as shown in FIG. 33, an exhaust portion 140 is provided in place of the collection side extended tube portion 14A shown in FIG. 19. The exhaust portion 140 has a plurality of exhaust holes 142 (hereinafter referred to as the exhaust hole group 143) aligned in the longitudinal direction H of the face of the user 900, similar to the collection side extended tube portion 14A. Note that There may be only one exhaust hole 142. The gas that has passed through the exhaust hole 142 is released outside the exhaust portion 140. The extended tube portion 5B and the exhaust portion 140 are arranged so that the first supply hole group 51 and the exhaust hole group 143 of the exhaust portion 140 are placed by the disposition unit 6 on both outer sides of the face of the user 900 through the mouth vicinity area 930 in the width direction W, and are opposite to each other in the width direction W. As a result, the gas supplied from the gas supply unit 2 flows in the width direction W of the face of the user 900 in the mouth vicinity area 930. Note that the extended tube portion 5B and the exhaust portion 140 may be configured so that the nose vicinity area 960 is included between the first supply hole group 51 and the exhaust hole group 143 of the exhaust portion 140.

The exhaust portion 140 is provided with a filter portion (not shown) that is configured to capture viruses contained in the air passing through the exhaust portion 140. As a result, viruses can be removed from the air passing through the exhaust portion 140.

The filter portion has some airflow resistance because it has a virus-capturing structure inside. In a mask with a low degree of adhesion to the user 900, the exhaled air of the user 900 is not released from the filter portion, which has some ventilation resistance, but is released from the gap between the user 900 and the mask 800 near the outer edge. Therefore, the gas guide apparatus 1 according to the present embodiment is effective when the user 900 wears a mask 800 that has a high degree of adhesion to the user 900. The mask 800 that has a high degree of close contact to the user 900 has its own outer edge or the vicinity thereof in close contact with the skin of the user 900, so that there is almost no gap formed between the mask 800 and the user 900. Such a mask 800 is made of a material such as silicon, for example.

The gas guide apparatus 1 according to the present embodiment passes the gas through the mouth vicinity area 930 in the width direction W of the face of the user 900. This can prevent the mask 800 from sticking to the face.

The disposition unit 6 can be of any configuration as long as the extended tube portion 5B and the exhaust portion 140 are arranged as described above. For example, As shown in FIG. 33A, the disposition unit 6 may be configured to attach the extended tube portion 5B and the exhaust portion 140 to the mask 800. The extended tube portion 5B and the exhaust portion 140 are preferably arranged so that the first supply hole group 51 and the exhaust hole group 143 of the exhaust portion 140 face each other through the mouth vicinity area 930. In this case, for example, they may be arranged so as to face each other in the length direction H of the face of the user 900, or a direction inclined to the length direction of the face of the user 900. Furthermore, As shown in FIG. 33B, the extended tube portion 5B may be replaced by a non-tubular emission structure portion 5C that is connected to the inlet tube portion 5A and has a structure capable of emitting gas supplied through the inlet tube portion 5A to the outside through the supply hole 50. In other words, the gas supply side tube unit 4 may be composed of an inlet tube portion 5A and the emission structure portion. This can also be applied in other embodiments.

As shown in FIG. 33B, the emission structure portion 5C is attached by the disposition unit 6 so that it penetrates the mask 800 without any gaps between itself and the mask 800. The emission structure portion 5C has a emission side first portion 5D, which is located in the inner space of the mask 800 between the inner surface 850 of the mask 800 and the face (skin) of the user 900 and a emission side second portion 5E, which is located outside the mask 800. The emission side first portion 5D is continuous with the emission side second portion 5E. The emission side first portion 5D is provided with the supply hole (not shown). The emission side second portion 5E has a connection mechanism 5F to connect the inlet tube portion 5A. Inside the emission side first portion 5D and the emission side second portion 5E, a guide passage (not shown) is provided to guide the gas supplied through the inlet tube portion 5A to the supply hole 50. Note that the mask 800 shown in FIG. 33B, has a high degree of degree of close contact to the user 900. The inlet tube portion 5A is connected to the gas supply side regulator valve unit, as in FIG. 33A.

As shown in FIG. 33B, the exhaust portion 140 is attached by the disposition unit 6 so that it penetrates the mask 800 without any gaps between itself and the mask 800. The exhaust portion 140 has an exhaust side first portion 144, which is located in the inner space of the mask 800 between the inner surface 850 of the mask 800 and the face (skin) of the user 900, and an exhaust side second portion 145, which is located outside the mask 800. The exhaust side first portion 144 is continuous with the exhaust side second portion 145. The exhaust hole 142 (not shown) is provided in the exhaust side first portion 144. The exhaust side second portion 145 has an exhaust passage (not shown) that follows the exhaust hole 142. The filter portion (not shown) is then provided at either the exhaust hole 142 or the exhaust passage.

The exhaust side second portion 145 has an exhaust opening 146 for exhausting the gas passing through the exhaust passage to the outside. The mask 800 shown in FIG. 33B has a high degree of close contact to the user 900, so the inner space of the mask 800 between the inner surface 850 of the mask 800 and the face (skin) of the user 900 is almost a sealed space. Therefore, the exhaled air of the user 900 is exhausted to the outside through the exhaust portion 140. Furthermore, in the process of exhausting the exhaled air of the user 900, the exhaled air of the user 900 passes through the filter portion, and viruses and other substances contained in the exhaled air of the user 900 are captured by the filter portion. In the present embodiment, a configuration in which the exhaust portion 140 is absent and the gas supply side tube unit 4 is included, or a configuration in which the gas supply side tube unit 4 is absent and the exhaust portion 140 is included, is also included in the scope of the present invention.

Free combinations of each components of the gas guide apparatuses 1 according to the aforementioned first to thirteenth embodiments, or a free combinations of component pieces that are part of each components, are also included in the scope of the present invention.

It will be understood that the gas guide apparatus according to the present invention is not limited to the aforementioned embodiments, and various modifications can be made thereto without departing from the gist of the present invention.

What is claimed is:

1. A gas guide apparatus comprising:
a gas supply unit configured to supply a gas;
a gas supply side tube unit configured to guide the gas from the gas supply unit and to have a supply hole to emit the gas supplied from the gas supply unit; and
a disposition unit configured to dispose the gas supply side tube unit on a face or a head of a user with the supply hole located near the face or the head of the user.

2. The gas guide apparatus according to claim 1, wherein the disposition unit disposes the gas supply side tube unit so that the supply hole is located in a vicinity area of a mouth of the user.

3. The gas guide apparatus according to claim 1, comprising a filter unit located on any of a gas suction path and a gas supply path of the gas supply unit.

4. The gas guide apparatus according to claim 1, wherein the supply hole emits the gas from a band-like emission area formed by a combination of a plurality of holes and/or a slit-like long hole.

5-10. (canceled)

11. The gas guide apparatus according to claim 1, wherein the supply hole includes an upper hole that is located near a nose of the user and emits the gas to a front of an eye, and a lower hole that is located near the nose of the user and emits the gas to a front of a mouth.

12. The gas guide apparatus according to claim 11, comprising a guide surface that is opposed to the upper hole in a reference direction and tilts toward the front of the face, with a direction from the upper hole to the eye as the reference direction.

13-14. (canceled)

15. The gas guide apparatus according to claim 1, wherein:
the disposition unit includes a cover member engagement structure capable of engagement with a cover member configured to cover at least a mouth of the user to block a droplet from the mouth in an open state where the user is able to breathe freely; and
the supply hole supplies the gas to between the cover member and the user.

16. The gas guide apparatus according to claim 15, wherein:
the cover member is a mask configured to cover a nose and the mouth of the user with a sheet material having enough air permeability for the user to breathe freely; and
the cover member engagement structure includes hook portions to be engaged with portions of the mask to be put on both ears.

17. The gas guide apparatus according to claim 15, wherein:
the cover member is a mask configured to cover a nose and the mouth of the user with a sheet material having enough air permeability for the user to breathe freely; and
the disposition unit includes an engagement portion that is positioned on an inner surface side of the mask by being located on the inner surface side of the mask and engaged with an inner surface or a peripheral edge of the mask.

18-20. (canceled)

21. The gas guide apparatus according to claim 15, wherein:
the cover member is a face guard configured to cover at least a nose and the mouth of the user with a peripheral edge thereof open to outside; and
the cover member engagement structure includes
a face guard side frame portion that extends around the head of the user, and
a face guard side attachment portion that attaches the peripheral edge of the face guard to the face guard side frame portion in part.

22-34. (canceled)

35. The gas guide apparatus according to claim 1, having an exhaust hole that releases the gas emitted from the supply hole.

36. The gas guide apparatus according to claim 1, comprising:
a gas collection side tube unit that has a collection hole for collecting the gas emitted from the supply hole; and
a negative pressure generation unit configured to make inside of the gas collection side tube unit negative in pressure, wherein
the disposition unit disposes the gas collection side tube unit on the face or the head of the user so that the collection hole is located near the face or the head of the user.

37-40. (canceled)

41. The gas guide apparatus according to claim 36, wherein the disposition unit disposes the gas supply side tube unit and the gas collection side tube unit so that a mouth of the user is located between the supply hole and the collection hole.

42-49. (canceled)

50. The gas guide apparatus according to claim 1, comprising a water absorbing member that is capable of retaining water, wherein
the water is vaporized by the gas emitted from the supply hole.

51-52. (canceled)

53. The gas guide apparatus according to claim 1, comprising a neck-specific gas supply side tube unit configured to guide the gas from the gas supply unit and to have a neck side supply hole for emitting the gas supplied from the gas supply unit to near a neck of the user.

54-55. (canceled)

56. The gas guide apparatus according to claim 1, comprising
a pressure measurement unit configured to measure a pressure of the gas emitted from the supply hole, and
a control unit including a computer, wherein
the control unit includes a supply flow rate controller configured to control a flow rate of the gas emitted from the supply hole on a basis of a pressure evaluation value derived from a result of a pressure measurement made by the pressure measurement unit.

57. (canceled)

58. The gas guide apparatus according to claim 36, comprising:
a pressure measurement unit configured to measure a pressure of the gas emitted from the supply hole; and
a control unit including a computer, wherein
the control unit includes a collection flow rate controller configured to control an amount of gas collection from the collection hole on a basis of a pressure evaluation value derived from a result of a pressure measurement made by the pressure measurement unit.

59-61. (canceled)

62. The gas guide apparatus according to claim 1, comprising an exhaust portion configured to have an exhaust hole to release the gas emitted from the gas from the supply hole to the outside, wherein
the disposition unit disposes the exhaust portion with the exhaust hole located near the face of the user.

63. The gas guide apparatus according to claim 62, wherein the disposition unit disposes the gas supply side tube unit and the exhaust portion so that a mouth of the user is located between the supply hole and the exhaust hole.

64. The gas guide apparatus according to claim 62, wherein the exhaust portion has a filter portion for the gas released from the exhaust hole to pass through.

65. A gas guide apparatus comprising:
a gas collection side tube unit configured to have a collection hole for collecting a gas;
a negative pressure generation unit configured to make an inside of the gas collection side tube unit negative in pressure; and
a disposition unit configured to dispose the gas collection side tube unit on a face of a user with the collection hole located near the face of the user.
